(19) United States
(12) Patent Application Publication
(10) Pub. No.: US 2024/0276594 A1
(43) Pub. Date: Aug. 15, 2024

(54) COMMUNICATION SKIPPING IN DISCONTINUOUS RECEPTION

(71) Applicant: QUALCOMM Incorporated, San Diego, CA (US)

(72) Inventors: Hung Dinh LY, San Diego, CA (US); Yan ZHOU, San Diego, CA (US)

(21) Appl. No.: 18/501,969

(22) Filed: Nov. 3, 2023

Related U.S. Application Data
(60) Provisional application No. 63/485,158, filed on Feb. 15, 2023.

(51) Int. Cl. H04W 76/28

(52) U.S. Cl. CPC H04W 76/28

(57) ABSTRACT

Various aspects of the present disclosure generally relate to wireless communication. In some aspects, a user equipment (UE) may transmit an indication that the UE performs measurement of one or more reference signals during one or more discontinuous reception (DRX) inactive times of one or more DRX cycles. The UE may receive, responsive to the indication, the one or more reference signals during a DRX inactive time, of the one or more DRX inactive times, of a DRX cycle of the one or more DRX cycles. Numerous other aspects are described.

### CROSS-REFERENCE TO RELATED APPLICATION

This Patent application claims priority to U.S. Provisional Patent Application No. 63/485,158, filed on Feb. 15, 2023, entitled “COMMUNICATION SKIPPING IN DISCONTINUOUS RECEPTION,” and assigned to the assignee hereof. The disclosure of the prior Application is considered part of and is incorporated by reference into this Patent Application.

### INTRODUCTION

Aspects of the present disclosure generally relate to wireless communication and to techniques and apparatuses for discontinuous reception.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed at an apparatus of a user equipment (UE). The method may include transmitting an indication that the UE performs measurement of one or more reference signals during one or more discontinuous reception (DRX) inactive times of one or more DRX cycles. The method may include receiving, responsive to the indication, the one or more reference signals during a DRX inactive time, of the one or more DRX inactive times, of a DRX cycle of the one or more DRX cycles.

Some aspects described herein relate to a method of wireless communication performed at an apparatus of a network node. The method may include receiving an indication that a UE performs measurement of one or more reference signals during one or more DRX inactive times of one or more DRX cycles. The method may include transmitting, responsive to the indication, the one or more reference signals during a DRX inactive time, of the one or more DRX inactive times, of a DRX cycle of the one or more DRX cycles.

Some aspects described herein relate to a method of wireless communication performed at an apparatus of a UE. The method may include receiving information identifying a time duration of a DRX inactive time of a DRX cycle, the time duration being for applying an indication to skip at least one of transmission or reception during the DRX inactive time. The method may include communicating during the time duration in accordance with the indication.

Some aspects described herein relate to a method of wireless communication performed at an apparatus of a network node. The method may include transmitting information identifying a time duration of a DRX inactive time of a DRX cycle, the time duration being for applying an indication to skip at least one of transmission or reception during the DRX inactive time. The method may include communicating during the time duration in accordance with the indication.

Some aspects described herein relate to an apparatus for wireless communication at a UE. The apparatus may include a memory and one or more processors coupled to the memory. The one or more processors may be configured to transmit an indication that the UE performs measurement of one or more reference signals during one or more DRX inactive times of one or more DRX cycles. The one or more processors may be configured to receive, responsive to the indication, the one or more reference signals during a DRX inactive time, of the one or more DRX inactive times, of a DRX cycle of the one or more DRX cycles.

Some aspects described herein relate to an apparatus for wireless communication at a network node. The apparatus may include a memory and one or more processors coupled to the memory. The one or more processors may be configured to receive an indication that a UE performs measurement of one or more reference signals during one or more DRX inactive times of one or more DRX cycles. The one or more processors may be configured to transmit, responsive to the indication, the one or more reference signals during a DRX inactive time, of the one or more DRX inactive times, of a DRX cycle of the one or more DRX cycles.

Some aspects described herein relate to an apparatus for wireless communication at a UE. The apparatus may include a memory and one or more processors coupled to the memory. The one or more processors may be configured to receive information identifying a time duration of a DRX inactive time of a DRX cycle, the time duration being for applying an indication to skip at least one of transmission or reception during the DRX inactive time. The one or more processors may be configured to communicate during the time duration in accordance with the indication.

Some aspects described herein relate to an apparatus for wireless communication at a network node. The apparatus may include a memory and one or more processors coupled to the memory. The one or more processors may be configured to transmit information identifying a time duration of a DRX inactive time of a DRX cycle, the time duration being for applying an indication to skip at least one of transmission or reception during the DRX inactive time. The one or more processors may be configured to communicate during the time duration in accordance with the indication.

Some aspects described herein relate to a non-transitory computer-readable medium that stores a set of instructions for wireless communication by a UE. The set of instructions, when executed by one or more processors of the UE, may cause the UE to transmit an indication that the UE performs measurement of one or more reference signals during one or more DRX inactive times of one or more DRX cycles. The set of instructions, when executed by one or more processors of the UE, may cause the UE to receive, responsive to the indication, the one or more reference signals during a DRX inactive time, of the one or more DRX inactive times, of a DRX cycle of the one or more DRX cycles.

Some aspects described herein relate to a non-transitory computer-readable medium that stores a set of instructions for wireless communication by a network node. The set of instructions, when executed by one or more processors of the network node, may cause the network node to receive an indication that a UE performs measurement of one or more reference signals during one or more DRX inactive times of one or more DRX cycles. The set of instructions, when executed by one or more processors of the network node, may cause the network node to transmit, responsive to the indication, the one or more reference signals during a DRX inactive time, of the one or more DRX inactive times, of a DRX cycle of the one or more DRX cycles.

Some aspects described herein relate to a non-transitory computer-readable medium that stores a set of instructions for wireless communication by a UE. The set of instructions, when executed by one or more processors of the UE, may cause the UE to receive information identifying a time duration of a DRX inactive time of a DRX cycle, the time duration being for applying an indication to skip at least one of transmission or reception during the DRX inactive time. The set of instructions, when executed by one or more processors of the UE, may cause the UE to communicate during the time duration in accordance with the indication.

Some aspects described herein relate to a non-transitory computer-readable medium that stores a set of instructions for wireless communication by a network node. The set of instructions, when executed by one or more processors of the network node, may cause the network node to transmit information identifying a time duration of a DRX inactive time of a DRX cycle, the time duration being for applying an indication to skip at least one of transmission or reception during the DRX inactive time. The set of instructions, when executed by one or more processors of the network node, may cause the network node to communicate during the time duration in accordance with the indication.

Some aspects described herein relate to an apparatus for wireless communication. The apparatus may include means for transmitting an indication that the apparatus performs measurement of one or more reference signals during one or more DRX inactive times of one or more DRX cycles. The apparatus may include means for receiving, responsive to the indication, the one or more reference signals during a DRX inactive time, of the one or more DRX inactive times, of a DRX cycle of the one or more DRX cycles.

Some aspects described herein relate to an apparatus for wireless communication. The apparatus may include means for receiving an indication that a UE performs measurement of one or more reference signals during one or more DRX inactive times of one or more DRX cycles. The apparatus may include means for transmitting, responsive to the indication, the one or more reference signals during a DRX inactive time, of the one or more DRX inactive times, of a DRX cycle of the one or more DRX cycles.

Some aspects described herein relate to an apparatus for wireless communication. The apparatus may include means for receiving information identifying a time duration of a DRX inactive time of a DRX cycle, the time duration being for applying an indication to skip at least one of transmission or reception during the DRX inactive time. The apparatus may include means for communicating during the time duration in accordance with the indication.

Some aspects described herein relate to an apparatus for wireless communication. The apparatus may include means for transmitting information identifying a time duration of a DRX inactive time of a DRX cycle, the time duration being for applying an indication to skip at least one of transmission or reception during the DRX inactive time. The apparatus may include means for communicating during the time duration in accordance with the indication.

Some aspects described herein relate to an apparatus for wireless communication at a UE. The apparatus may include one or more memories and one or more processors coupled to the one or more memories. The one or more processors may be configured to cause the UE to transmit an indication that the UE performs measurement of one or more reference signals during one or more DRX inactive times of one or more DRX cycles. The one or more processors may be configured to cause the UE to receive, responsive to the indication, the one or more reference signals during a DRX inactive time, of the one or more DRX inactive times, of a DRX cycle of the one or more DRX cycles.

Some aspects described herein relate to an apparatus for wireless communication at a network node. The apparatus may include one or more memories and one or more processors coupled to the one or more memories. The one or more processors may be configured to cause the network node to receive an indication that a UE performs measurement of one or more reference signals during one or more DRX inactive times of one or more DRX cycles. The one or more processors may be configured to cause the network node to transmit, responsive to the indication, the one or more reference signals during a DRX inactive time, of the one or more DRX inactive times, of a DRX cycle of the one or more DRX cycles.

Some aspects described herein relate to an apparatus for wireless communication at a UE. The apparatus may include one or more memories and one or more processors coupled to the one or more memories. The one or more processors may be configured to cause the UE to receive information identifying a time duration of a DRX inactive time of a DRX cycle, the time duration being for applying an indication to skip at least one of transmission or reception during the DRX inactive time. The one or more processors may be configured to cause the UE to communicate during the time duration in accordance with the indication.

Some aspects described herein relate to an apparatus for wireless communication at a network node. The apparatus may include one or more memories and one or more processors coupled to the one or more memories. The one or more processors may be configured to cause the network node to transmit information identifying a time duration of a DRX inactive time of a DRX cycle, the time duration being for applying an indication to skip at least one of transmission or reception during the DRX inactive time. The one or more processors may be configured to cause the network node to communicate during the time duration in accordance with the indication.

Aspects generally include a method, apparatus, system, computer program product, non-transitory computer-readable medium, user equipment, base station, network entity, network node, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of beam management procedures, in accordance with the present disclosure.

FIG. 5 is a diagram illustrating an example of a discontinuous reception (DRX) configuration, in accordance with the present disclosure.

FIG. 6 is a diagram illustrating an example of a sidelink DRX configuration, in accordance with the present disclosure.

FIG. 7A is a diagram illustrating an example of network DRX and discontinuous transmission (DTX), in accordance with the present disclosure.

FIG. 7B is a diagram illustrating an example of network DRX and DTX, in accordance with the present disclosure.

FIG. 8 is a diagram of an example associated with communication skipping in DRX, in accordance with the present disclosure.

FIGS. 9A-9C are diagrams of examples associated with communication skipping in DRX, in accordance with the present disclosure.

FIG. 10 is a diagram of an example associated with communication skipping in DRX, in accordance with the present disclosure.

FIG. 11 is a diagram of an example associated with communication skipping in DRX, in accordance with the present disclosure.

FIG. 12 is a diagram illustrating an example process performed, for example, by a UE, in accordance with the present disclosure.

FIG. 13 is a diagram illustrating an example process performed, for example, by a network node, in accordance with the present disclosure.

FIG. 14 is a diagram illustrating an example process performed, for example, by a UE, in accordance with the present disclosure.

FIG. 15 is a diagram illustrating an example process performed, for example, by a network node, in accordance with the present disclosure.

FIG. 16 is a diagram of an example apparatus for wireless communication, in accordance with the present disclosure.

FIG. 17 is a diagram illustrating an example of a hardware implementation for an apparatus employing a processing system, in accordance with the present disclosure.

FIG. 18 is a diagram illustrating an example of an implementation of code and circuitry for an apparatus, in accordance with the present disclosure.

FIG. 19 is a diagram of an example apparatus for wireless communication, in accordance with the present disclosure.

FIG. 20 is a diagram illustrating an example of a hardware implementation for an apparatus employing a processing system, in accordance with the present disclosure.

FIG. 21 is a diagram illustrating an example of an implementation of code and circuitry for an apparatus, in accordance with the present disclosure.

### DETAILED DESCRIPTION

A user equipment (UE) may operate using discontinuous reception (DRX) to conserve power. The UE may perform DRX according to a DRX cycle that repeats with a configured periodicity. A DRX cycle may include a DRX on duration (e.g., during which the UE is awake or in an active state) and a DRX off duration (e.g., during which the UE has an opportunity to enter a sleep state). During the DRX on duration, the UE may be in an active state to monitor a downlink control channel (e.g., a physical downlink control channel (PDCCH)) for downlink control information (DCI) pertaining to the UE. If the UE does not detect the DCI, then the UE may enter a sleep state (e.g., by not performing transmission and/or reception, and/or by deactivating one or more components of the UE) at the end of the DRX on duration and at the start of the DRX off duration. If the UE detects the DCI, then the UE may remain in the active state for the duration of a timer (which may be referred to as an “inactivity timer”) to transmit and/or receive communications. Accordingly, the UE may remain in the active state in a portion of the DRX off duration until the timer expires, at which time the UE may enter the sleep state for a remaining portion of the DRX off duration.

“DRX active time” or “DRX active duration” may refer to a time interval of a DRX cycle corresponding to a DRX on duration (e.g., if the UE does not decode any PDCCH communications intended for the UE in the DRX on duration) or corresponding to a DRX on duration and a portion of a DRX off duration in which the timer is running (e.g., if the UE does decode a PDCCH communication intended for the UE in the DRX on duration). “DRX inactive time” or “DRX inactive duration” may refer to a time interval of a DRX cycle corresponding to a DRX off duration (e.g., if the UE does not decode any PDCCH communications intended for the UE in a preceding DRX on duration) or corresponding to a portion of a DRX off duration after expiration of the timer (e.g., if the UE does decode a PDCCH communication intended for the UE in a preceding DRX on duration). In some examples, the UE may transmit and/or receive communications during a DRX inactive time. For example, the UE may receive communications that are configured to occur periodically, such as periodic reference signals. Transmission and/or reception by the UE outside of a DRX active time may reduce opportunities for a network node to enter a sleep state.

Accordingly, the network node may provide an indication (which may be referred to as a “skipping indication”) to the UE indicating that the UE is to skip (e.g., drop) transmission and/or reception of particular communications that may otherwise be communicated during DRX inactive times. For example, the skipping indication (e.g., information in DCI, in a medium access control (MAC) control element, or in radio resource control (RRC) signaling) may indicate one or more types of communications (e.g., semi-persistent scheduling (SPS) communications and/or configured grant communications, among other examples) for which the UE is to skip transmission and/or reception during DRX inactive times. The skipping indication may enable the network node to reduce transmission and/or reception during DRX inactive times, thereby improving power savings for the network node. However, such a reduction in transmission and/or reception may impact overall performance in a wireless network. For example, a UE may measure reference signals transmitted by the network node to establish (or re-establish) and maintain a reliable communication link with the network. In some cases, reference signals may be transmitted periodically in DRX inactive times. Thus, if the UE skips reception of the reference signals in a DRX inactive time, in accordance with the skipping indication, reception of a reference signal by the UE may be delayed until a DRX active time, thereby impacting overall communication latency.

Some techniques and apparatus described herein enable the UE to receive and measure reference signals in a DRX inactive time. In some aspects, the UE may transmit an indication (which may be referred to as a “measurement indication”) that the UE performs (e.g., that the UE has the capability to perform) measurement of a reference signal in a DRX inactive time. For example, the measurement indication may indicate a capability of the UE to perform the measurements, and may be provided in a UE capability information message (e.g., transmitted via RRC signaling). The measurement indication may provide an exception to a skipping indication transmitted by the network node. The network node, responsive to the measurement indication, may transmit a reference signal to the UE in a DRX inactive time, and the UE may receive and measure the reference signal in the DRX inactive time. In this way, an amount of delay in the UE receiving and measuring the reference signal may be reduced, thereby improving communication latency and overall performance of the UE's communications.

In some examples, multiple UEs in a cell may perform DRX according to the same DRX cycle. However, DRX active times of the UEs may be different (e.g., may not fully overlap in time), which may be due to the UEs being configured with different DRX inactivity timer durations and/or due to the UEs initiating DRX inactivity timers at different times. Accordingly, if the network node has provided skipping indications to one or more UEs, a maximum time duration in which the network node may drop transmission and/or reception in accordance with the skipping indications may correspond to a time overlap of DRX inactive times across all UEs in the cell. A UE may lack information regarding the DRX inactive times of other UEs. As a result, the UE may follow a skipping indication during the UE's inactive time even if the network node is active and communicating with other UEs that have not entered a sleep state. As a result, communications at the UE may be delayed, thereby affecting overall communication latency.

Some techniques and apparatuses described herein enable indication of a time duration corresponding to a time overlap of DRX inactive times across all UEs in a cell. For example, the UE may receive information (e.g., configuration information, such as in an RRC configuration) from the network node that identifies the time duration. During the time duration, the UE may apply a skipping indication, and outside of the time duration the UE may communicate without applying the skipping indication. In this way, an amount of delay of communications of the UE may be reduced, thereby improving data communication latency and overall performance of the UE's communications.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

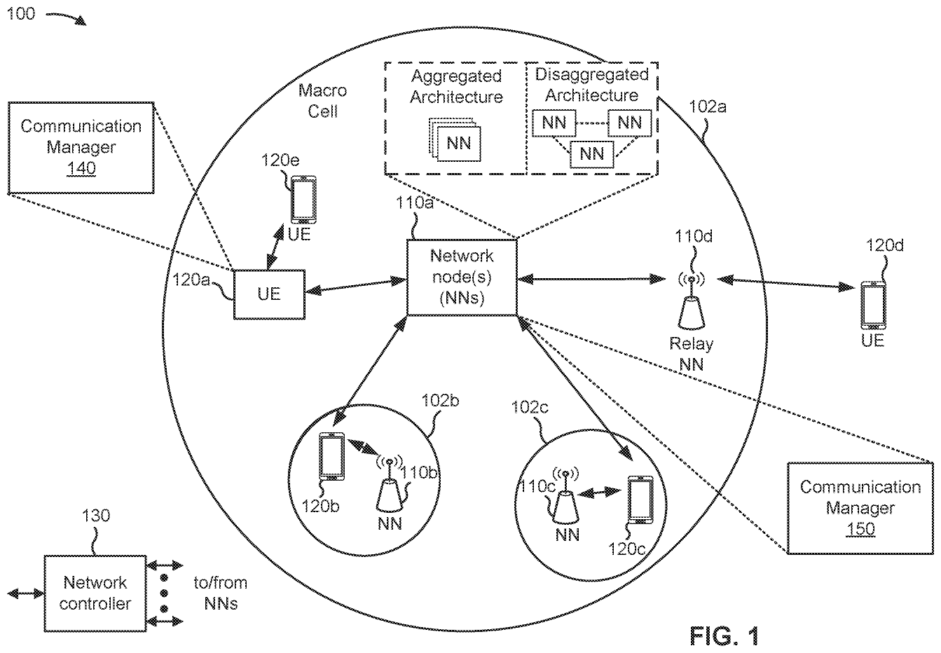

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit an indication that the UE 120 performs measurement of one or more reference signals during one or more DRX inactive times of one or more DRX cycles; and receive, responsive to the indication, the one or more reference signals during a DRX inactive time, of the one or more DRX inactive times, of a DRX cycle of the one or more DRX cycles. As described in more detail elsewhere herein, the communication manager 140 may receive information identifying a time duration of a DRX inactive time of a DRX cycle, the time duration being for applying an indication to skip at least one of transmission or reception during the DRX inactive time; and communicate during the time duration in accordance with the indication. Additionally, or alternatively, the communication manager 140 may perform one or more other operations described herein.

In some aspects, the network node 110 may include a communication manager 150. As described in more detail elsewhere herein, the communication manager 150 may receive an indication that a UE performs measurement of one or more reference signals during one or more DRX inactive times of one or more DRX cycles; and transmit, responsive to the indication, the one or more reference signals during a DRX inactive time, of the one or more DRX inactive times, of a DRX cycle of the one or more DRX cycles. As described in more detail elsewhere herein, the communication manager 150 may transmit information identifying a time duration of a DRX inactive time of a DRX cycle, the time duration being for applying an indication to skip at least one of transmission or reception during the DRX inactive time; and communicate during the time duration in accordance with the indication. Additionally, or alternatively, the communication manager 150 may perform one or more other operations described herein.

As indicated above, FIG. 1 is provided as an example. Other examples may differ from what is described with regard to FIG. 1.

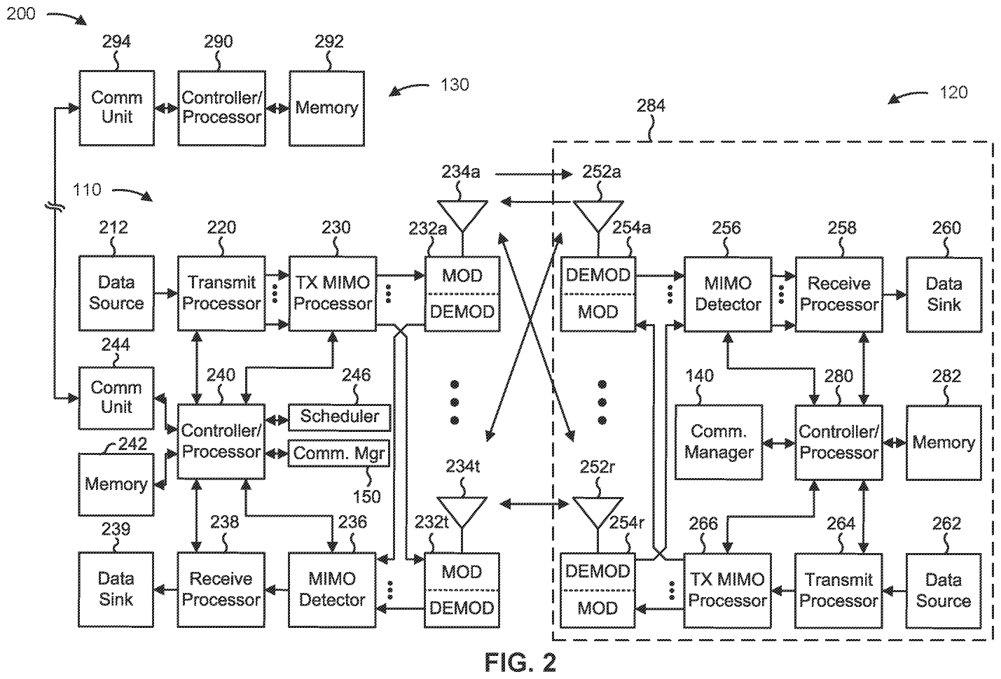

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

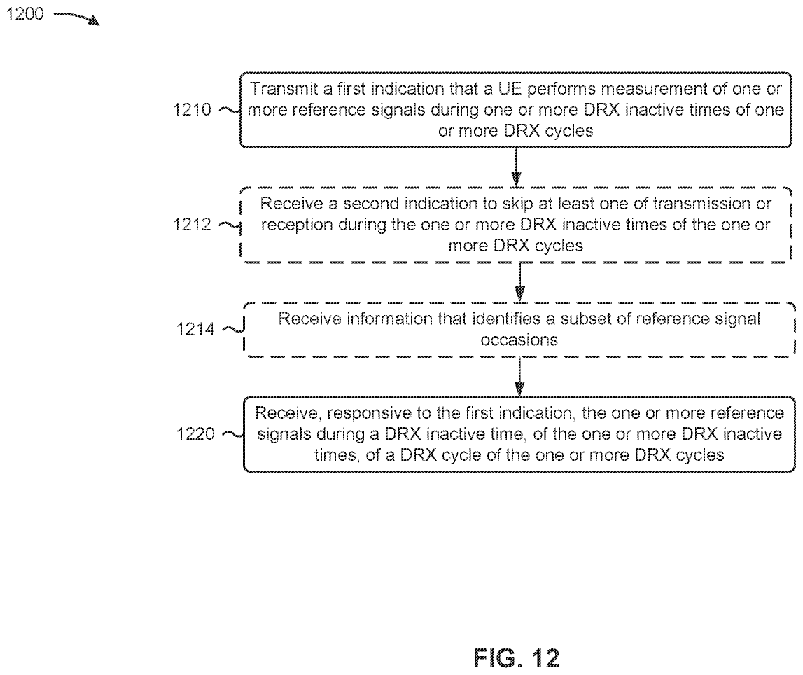

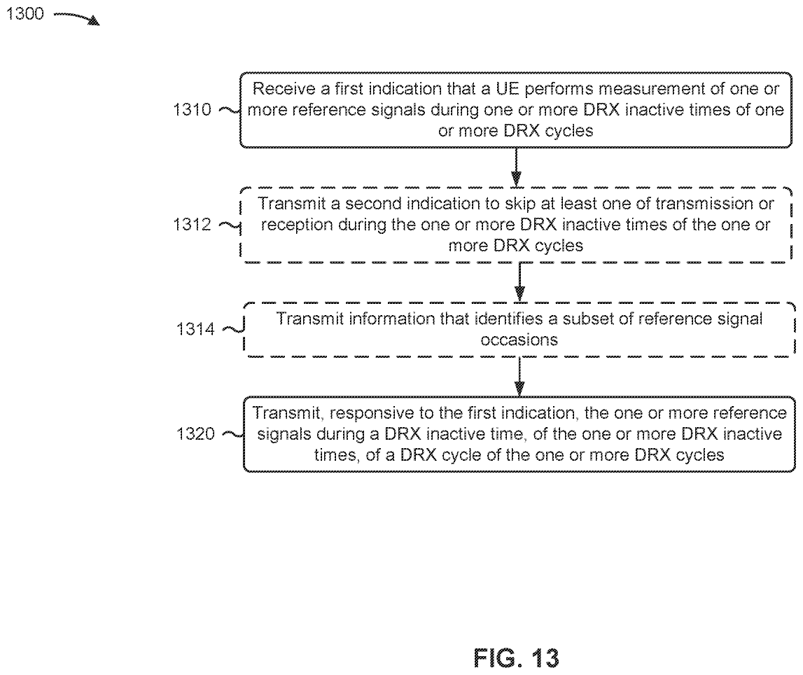

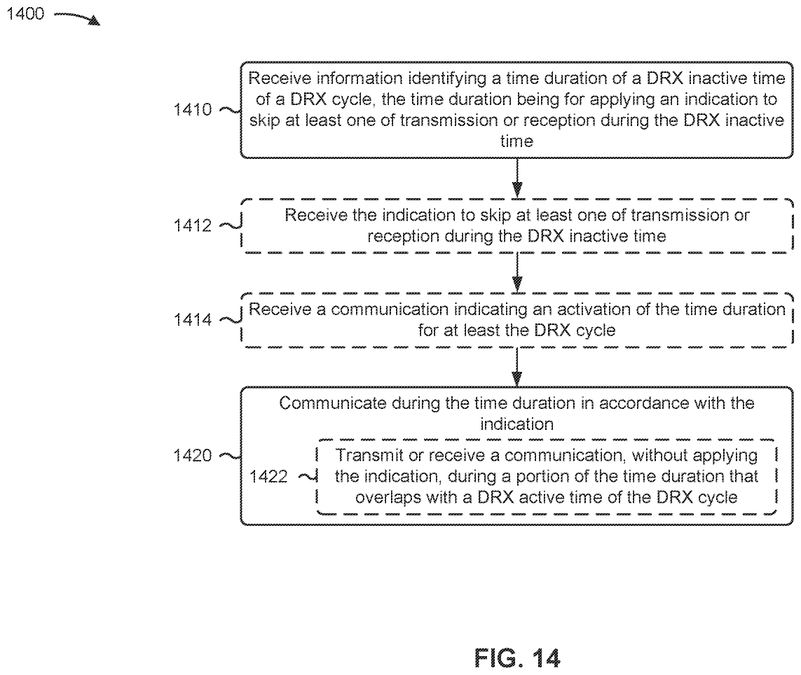

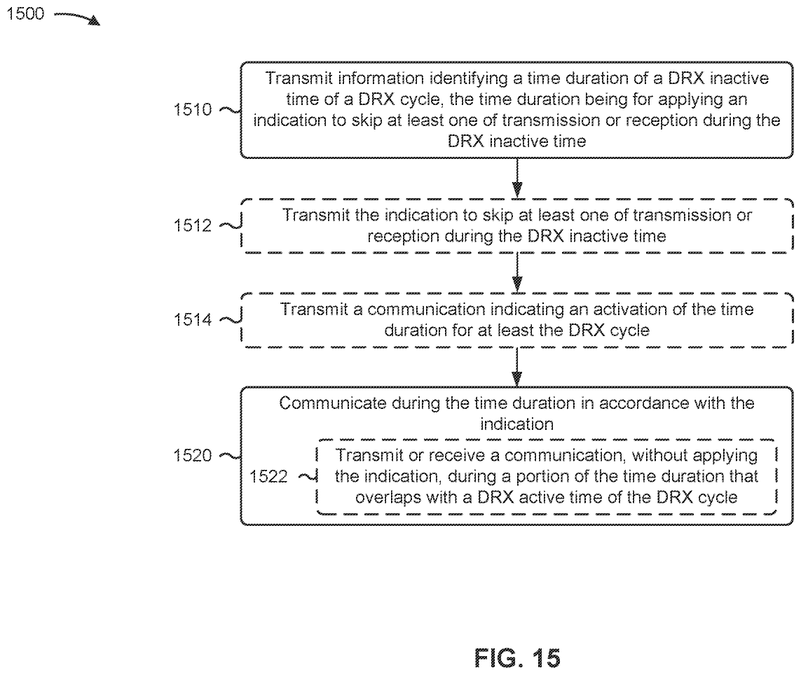

The controller/processor 240 of the network node 110, the controller/processor 280 of the UE 120, and/or any other component(s) of FIG. 2 may perform one or more techniques associated with communication skipping in DRX, as described in more detail elsewhere herein. For example, the controller/processor 240 of the network node 110, the controller/processor 280 of the UE 120, and/or any other component(s) of FIG. 2 may perform or direct operations of, for example, process 1200 of FIG. 12, process 1300 of FIG. 13, process 1400 of FIG. 14, process 1500 of FIG. 15, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1200 of FIG. 12, process 1300 of FIG. 13, process 1400 of FIG. 14, process 1500 of FIG. 15, and/or other processes as described herein. In some examples, executing instructions may include running the instructions, converting the instructions, compiling the instructions, and/or interpreting the instructions, among other examples.

In some aspects, the UE 120 includes means for transmitting an indication that the UE 120 performs measurement of one or more reference signals during one or more DRX inactive times of one or more DRX cycles; and/or means for receiving, responsive to the indication, the one or more reference signals during a DRX inactive time, of the one or more DRX inactive times, of a DRX cycle of the one or more DRX cycles. In some aspects, the UE 120 includes means for receiving information identifying a time duration of a DRX inactive time of a DRX cycle, the time duration being for applying an indication to skip at least one of transmission or reception during the DRX inactive time; and/or means for communicating during the time duration in accordance with the indication. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving an indication that a UE performs measurement of one or more reference signals during one or more DRX inactive times of one or more DRX cycles; and/or means for transmitting, responsive to the indication, the one or more reference signals during a DRX inactive time, of the one or more DRX inactive times, of a DRX cycle of the one or more DRX cycles. In some aspects, the network node 110 includes means for transmitting information identifying a time duration of a DRX inactive time of a DRX cycle, the time duration being for applying an indication to skip at least one of transmission or reception during the DRX inactive time; and/or means for communicating during the time duration in accordance with the indication. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

In some aspects, the term “receive” and its conjugates (e.g., “receiving” and/or “received,” among other examples) may be alternatively referred to as “obtain” or its respective conjugates (e.g., “obtaining” and/or “obtained,” among other examples). Similarly, the term “transmit” and its conjugates (e.g., “transmitting” and/or “transmitted,” among other examples) may be alternatively referred to as “provide” or its respective conjugates (e.g., “providing” and/or “provided,” among other examples), “generate” or its respective conjugates (e.g., “generating” and/or “generated,” among other examples), and/or “output” or its respective conjugates (e.g., “outputting” and/or “outputted,” among other examples).

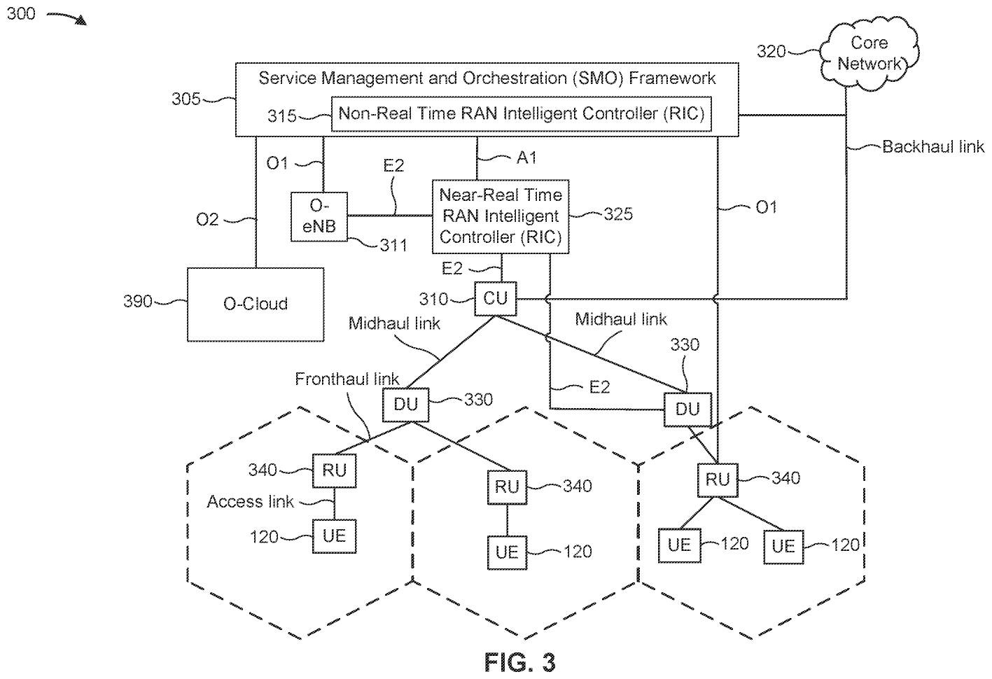

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

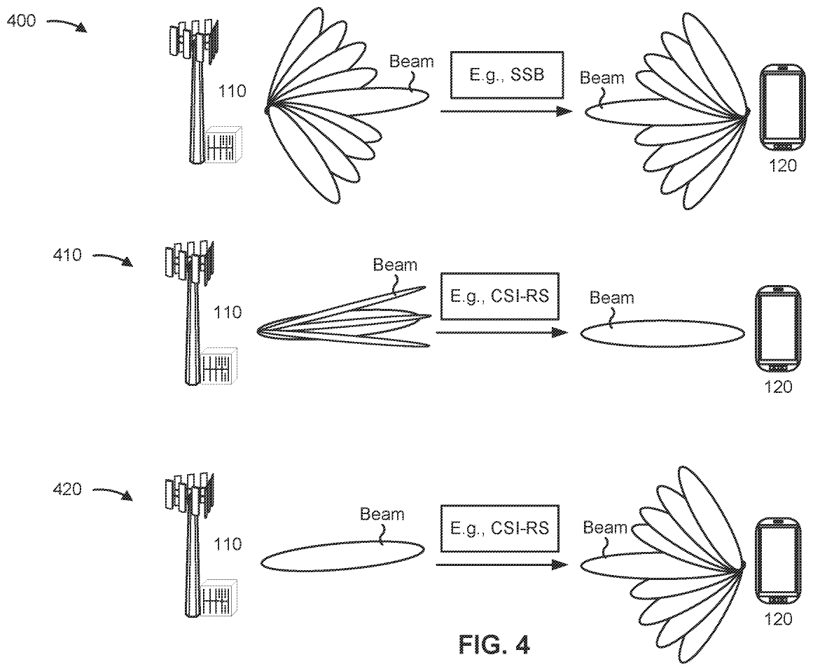

FIG. 4 is a diagram illustrating examples 400, 410, and 420 of beam management procedures, in accordance with the present disclosure. As shown in FIG. 4, examples 400, 410, and 420 include a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or TRP, between a mobile termination node and a control node, between an integrated access and backhaul (IAB) child node and an IAB parent node, and/or between a scheduled node and a scheduling node). In some examples, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management. Example 400 depicts a first beam management procedure (e.g., P1 beam management). The first beam management procedure may be referred to as a beam selection procedure, an initial beam acquisition procedure, a beam sweeping procedure, a cell search procedure, and/or a beam search procedure. As shown in FIG. 4 and example 400, synchronization signal blocks (SSBs) or channel state information reference signals (CSI-RSs) may be transmitted from the network node 110 to the UE 120. The CSI-RSs may be configured to be periodic (e.g., using RRC signaling), semi-persistent (e.g., using media access control (MAC) control element (MAC-CE) signaling), and/or aperiodic (e.g., using downlink control information (DCI)).

The first beam management procedure may include the network node 110 performing beam sweeping over multiple transmit (Tx) beams. The network node 110 may transmit an SSB and/or a CSI-RS using each transmit beam for beam management. To enable the UE 120 to perform receive (Rx) beam sweeping, the network node may use a transmit beam to transmit (e.g., with repetitions) each SSB and/or CSI-RS at multiple times within the same reference signal resource set so that the UE 120 can sweep through receive beams in multiple transmission instances. For example, if the network node 110 has a set of N transmit beams and the UE 120 has a set of M receive beams, the SSB and/or the CSI-RS may be transmitted on each of the N transmit beams M times so that the UE 120 may receive M instances of the SSB and/or the CSI-RS per transmit beam. In other words, for each transmit beam of the network node 110, the UE 120 may perform beam sweeping through the receive beams of the UE 120. As a result, the first beam management procedure may enable the UE 120 to measure (e.g., a Layer 1 (L1) RSRP measurement) an SSB and/or a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120.

As shown in FIG. 4, example 410 may include a network node 110 and a UE 120 communicating to perform beam management. Example 410 depicts a second beam management procedure (e.g., P2 beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams (e.g., a smaller set of transmit beams as compared to the first beam management procedure). The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). For example, the UE 120 may measure each CSI-RS without sweeping through receive beams. The second beam management procedure may enable the network node 110 to select a best transmit beam based at least in part on measurements of the CSI-RSs (e.g., measured by the UE 120 using the single receive beam) reported by the UE 120. For example, the UE 120 may report an index (e.g., a CSI-RS resource indicator (CRI)) and a signal strength (e.g., L1 RSRP) for the strongest beam(s).

As shown in FIG. 4, example 420 depicts a third beam management procedure (e.g., P3 beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management procedure may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RSs at multiple times (e.g., in quick succession) within the same reference signal resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams). In some examples, the UE 120 may select the best receive beam without reporting measurement results to the network node 110. Although the first, second, and third beam management procedures are described herein with reference to an SSB and/or a CSI-RS, another type of reference signal may be used, such as a positioning reference signal. Moreover, a beam management procedure described herein as being performed using an SSB may be performed using a CSI-RS or another reference signal, and a beam management procedure described herein as being performed using a CSI-RS may be performed using an SSB or another reference signal.

In some examples, the receive beam sweeping component of the first beam management procedure may be performed as a background process by the UE 120. However, due to an analog beamforming restriction, the receive beam sweeping may interrupt reception of physical downlink shared channel (PDSCH) communications. Accordingly, configuration by the network node 110 of designated signals, in the form of CSI-RSs repeated with the same beamforming, may be beneficial in order to initiate the third beam management procedure and support receive beam sweeping by the UE 120.

For beam reporting in connection with the beam management procedures, the UE 120 may report an index of one or more best beams using a CRI and/or an SSB/physical broadcast channel (PBCH) block resource index (SSBRI). As described herein, the UE 120 may report signal strength measurements, for the reported beams, in the form of L1 RSRP. In some cases, the UE 120 may report multiple beams. Here, the UE 120 may report an absolute RSRP for a strongest beam (e.g., a beam with the highest L1 RSRP), and the UE 120 may report a differential RSRP for one or more other beams.

In some examples, the network node 110 may indicate CSI-RS resource configurations to the UE 120 (e.g., using an NZP-CSI-RS-ResourceSet information element, which indicates a set of non-zero-power (NZP) CSI-RS resources (their identifiers) and set-specific parameters). When a CSI-RS is used for beam management, and when repetition is disabled by a CSI-RS resource configuration (e.g., a repetition parameter in the NZP-CSI-RS-ResourceSet information element is set to “off”), a set of CSI-RS resources may be configured, each with a single port or two ports. For example, within the set of CSI-RS resources, all resources have the same number of ports. Each resource may correspond to a respective transmit beam direction from the network node 110. In addition, the UE 120 may be configured to measure L1-RSRP for beam management (e.g., a reportQuantity parameter may be set to “cri-RSRP”). An L1-RSRP measurement may include a CSI-RS power on a CSI-RS port, if a single port is used, or an average power across two ports if two ports are used. The UE 120 may be expected to report the CRI of the strongest CSI-RS resources (although selecting the strongest CSI-RS resources to report is not a requirement; the UE 120 may be allowed to use other selection criteria as well) within the configured resource set, together with corresponding powers (e.g., L1-RSRP) sorted in descending order.

When a CSI-RS is used for beam management, and when repetition is enabled by a CSI-RS resource configuration (e.g., a repetition parameter in the NZP-CSI-RS-ResourceSet information element is set to “on”), the CSI-RS may be intended to be used for receive beam sweeping. Here, multiple configured resources may be associated with the same transmit beam direction. Moreover, the UE 120 may vary an analog beamforming direction in a receiver of the UE 120 and compare signal strengths in different directions. A receive direction with a strongest received signal may be subsequently used for receiving other signals from the corresponding transmit beam direction. In some cases, these operations are transparent, in that the UE 120 may not be expected to report measurement results to the network node 110.

When repetition is enabled, there may be no actual repetition parameters configured for the UE 120. Rather, in this context, “repetition” means that resources within the resource set have the same repeated transmit beam direction in order to make the receive beam sweeping operation of the UE 120 meaningful.

In some examples, the UE 120 may perform measurement of reference signals in connection with time and frequency tracking, beam failure detection (BFD), and/or radio link monitoring (RLM). In time and frequency tracking, the UE 120 may monitor one or more reference signals to maintain time and frequency synchronization of the set of reference signals. In BFD, the network node 110 may transmit one or more BFD reference signals (e.g., SSBs and/or CSI-RSs) to the UE 120. The UE 120 may attempt to detect and measure the BFD reference signals. Based at least in part on the UE 120 failing to detect a threshold quantity of the BFD reference signals or measurements of a threshold quantity of the BFD reference signals satisfying a measurement threshold, the UE 120 may determine that beam failure has occurred. In RLM, the network node 110 may transmit one or more RLM reference signals (e.g., SSBs and/or CSI-RSs) to the UE 120. The UE 120 may perform measurement of the RLM reference signals to determine whether a radio link between the UE 120 and the network node 110 has failed. When the UE 120 determines that the radio link has failed (e.g., if estimated link qualities of all RLM reference signals fail to satisfy a threshold), the UE 120 may provide an indication to the network node 110.

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

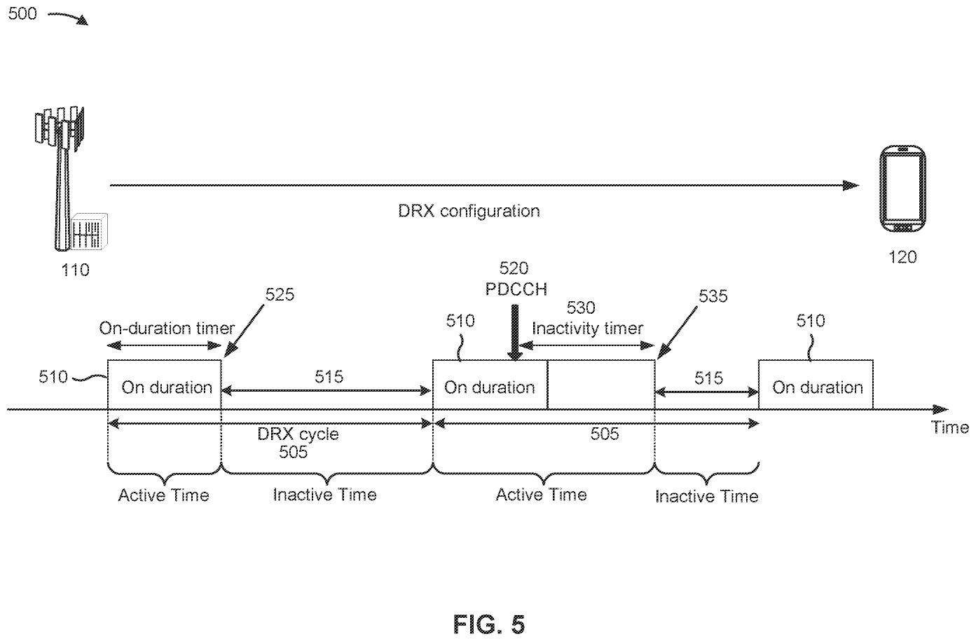

FIG. 5 is a diagram illustrating an example 500 of a DRX configuration, in accordance with the present disclosure. As shown in FIG. 5, example 500 includes a UE 120 in communication with a network node 110. In some examples, the UE 120 may be in a connected state (e.g., an RRC connected state) with the network node 110. For example, the DRX configuration may be for connected mode DRX (C-DRX).

As shown in FIG. 5, the network node 110 may transmit a DRX configuration to the UE 120 to configure a DRX cycle 505 for the UE 120. A DRX cycle 505 may include a DRX on duration 510 (e.g., during which the UE 120 is awake or in an active state) and a DRX off duration 515 (e.g., during which the UE 120 has an opportunity to enter a DRX sleep state).

During the DRX on duration 510, the UE 120 may be in an active state to monitor a downlink control channel (e.g., a physical downlink control channel (PDCCH)), as shown by reference number 520. For example, the UE 120 may monitor the PDCCH for DCI pertaining to the UE 120. If the UE 120 does not detect and/or successfully decode any PDCCH communications intended for the UE 120 during the DRX on duration 510, then the UE 120 may enter a sleep state at the end of the DRX on duration 510, during the DRX off duration 515, as shown by reference number 525. In the sleep state, the UE 120 may refrain from transmitting or receiving on an access link, may deactivate particular subcarriers or component carriers of the access link, and/or may deactivate one or more components of the UE 120. In this way, the UE 120 may conserve battery power and reduce power consumption. As shown, the DRX cycle 505 may repeat with a configured periodicity according to the DRX configuration.

If the UE 120 detects and/or successfully decodes a PDCCH communication intended for the UE 120, then the UE 120 may remain in the active state (e.g., awake) for the duration of a DRX inactivity timer 530 (e.g., which may extend the active time).

The UE 120 may start the DRX inactivity timer 530 at a time at which the PDCCH communication is received (e.g., in a transmission time interval (TTI) in which the PDCCH communication is received, such as a slot or a subframe). The UE 120 may remain in the active state until the DRX inactivity timer 530 expires, at which time the UE 120 may enter a sleep state (e.g., for a remainder of a DRX off duration 515), as shown by reference number 535. During the duration of the DRX inactivity timer 530, the UE 120 may continue to monitor for PDCCH communications, may obtain a downlink data communication (e.g., on a downlink data channel, such as a PDSCH) scheduled by the PDCCH communication, and/or may prepare and/or transmit an uplink communication (e.g., on a physical uplink shared channel (PUSCH)) scheduled by the PDCCH communication. The UE 120 may restart the DRX inactivity timer 530 after each detection of a PDCCH communication for the UE 120 for an initial transmission (e.g., but not for a retransmission). By operating in this manner, the UE 120 may conserve battery power and reduce power consumption by entering the sleep state.

As described herein, a DRX active time of the UE 120 may be a time in which the UE 120 is in an active state, which may correspond to a DRX on duration 510 (e.g., if the UE 120 does not decode any PDCCH communications intended for the UE 120) or may correspond to a DRX on duration 510 and a portion of a DRX off duration 515 in which the DRX inactivity timer 530 is running (e.g., if the UE 120 does decode a PDCCH communication intended for the UE 120). A DRX inactive time of the UE 120 may be a remainder of a DRX cycle 505 after the DRX active time. For example, a DRX inactive time of the UE 120 may be a time in which the UE 120 is in a sleep state (e.g., an inactive state), which may correspond to a DRX off duration 515 (e.g., if the UE 120 does not decode any PDCCH communications intended for the UE 120) or may correspond to a portion of a DRX off duration 515 after expiration of the DRX inactivity timer 530 (e.g., if the UE 120 does decode a PDCCH communication intended for the UE 120).

In some examples, the UE 120 may transmit or receive communications outside of an active time for the UE 120. For example, outside of an active time, the UE 120 may receive system information, a radio resource management (RRM) reference signal, a beam management reference signal, a BFD reference signal, a PDSCH communication in accordance with semi-persistent scheduling (SPS), and/or a PDSCH communication scheduled by a dynamic grant of a PDCCH communication received in an active time (e.g., when a K0 value is larger than the DRX inactivity timer 530, where the K0 value represents a timing offset (e.g., in number of slots) between a slot containing the PDCCH communication with scheduling DCI (carrying a grant that schedules the PDSCH communication) and a slot containing the scheduled PDSCH communication (scheduled by the scheduling DCI)). As another example, outside of an active time, the UE 120 may transmit a scheduling request, a communication in accordance with a configured grant, a random access channel (RACH) communication (e.g., a PRACH-ResourceDedicatedBFR for beam failure recovery (BFR)), a PUSCH communication scheduled by a dynamic grant of a PDCCH communication received in an active time, and/or a physical uplink control channel (PUCCH) communication carrying hybrid automatic repeat request acknowledgment feedback (HARQ-ACK) for a PDSCH communication scheduled by a PDCCH communication received in an active time. Transmission or reception by the UE 120 outside of an active time may limit opportunities for the network node 110 to enter a deep sleep (e.g., a deeper sleep than a micro sleep having a symbol-level granularity).

As indicated above, FIG. 5 is provided as an example. Other examples may differ from what is described with respect to FIG. 5.

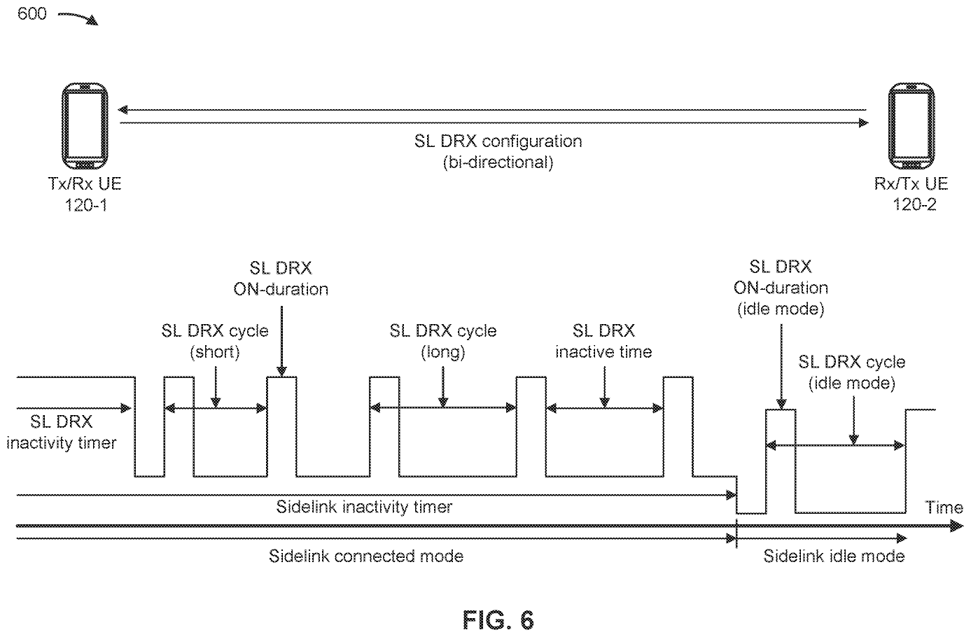

FIG. 6 is a diagram illustrating an example 600 of a sidelink DRX configuration, in accordance with the present disclosure. In some cases, as described above with reference to FIG. 5, a network node may provide a UE with a DRX configuration for an access link between the UE and the network node, to conserve battery life or otherwise reduce power consumption of the UE.

In some cases, a UE may be configured to communicate with another UE over a sidelink. Accordingly, in some cases, a UE may be configured to perform DRX operation on the sidelink. For example, in FIG. 6, a UE 120-1 may be transmitting a sidelink communication to a UE 120-2, and the UE 120-1 may provide a sidelink DRX configuration to the UE 120-2. Furthermore, in sidelink communication, transmission between each UE pair is bi-directional, whereby each UE may be a transmitter UE and a receiver UE.

As shown in FIG. 6, a UE 120 may perform sidelink DRX operation in various sidelink connectivity modes, such as a sidelink connected mode (e.g., an RRC connected mode on one or more sidelinks) and/or a sidelink idle mode (e.g., an RRC idle mode). In some aspects, the UE 120 may perform sidelink DRX operation in other sidelink connectivity modes, such as a sidelink inactive mode (e.g., an RRC inactive mode on one or more sidelinks).

As further shown in FIG. 6, the UE 120 may initiate sidelink DRX operation based on expiration of a sidelink DRX inactivity timer. In some aspects, the UE 120 may initiate sidelink DRX operation prior to expiration of the sidelink DRX inactivity timer, such as based on expiration of a sidelink inactivity timer (e.g., which may cause the UE 120 to transition from the sidelink connected mode to the sidelink idle mode) and/or based on operation of another UE.

In some aspects, the UE 120 may determine whether the sidelink DRX inactivity timer has expired based on a time duration since the UE 120 last transmitted and/or received a sidelink communication. For example, the UE 120 may determine that the sidelink DRX inactivity timer has expired based on not transmitting and/or not receiving a sidelink communication during the time duration and/or based on transmitting and/or receiving a quantity of sidelink communications, during the time duration, that fails to satisfy a threshold.

Similarly, the UE 120 may determine whether the sidelink inactivity timer has expired based on a time duration since the UE 120 last transmitted and/or last received a sidelink communication. The time duration associated with the sidelink inactivity timer may be different (e.g., longer) relative to the time duration associated with the sidelink DRX inactivity timer. For example, the UE 120 may determine that the sidelink inactivity timer has expired based on not transmitting and/or not receiving a sidelink communication during the time duration and/or based on transmitting and/or receiving a quantity of sidelink communications, during the time duration, that fails to satisfy a threshold.

As further shown in FIG. 6, the UE 120 may perform sidelink DRX operation based on a sidelink DRX cycle. The sidelink DRX cycle may include a combination of a sidelink DRX ON-duration and a sidelink DRX sleep state. The UE 120 may operate in the sidelink DRX sleep state for a sidelink DRX sleep duration or inactive time. In the sidelink DRX sleep state, the UE 120 may refrain from transmitting or receiving on the sidelink, may deactivate particular subcarriers or component carriers (e.g., if carrier aggregation is implemented on the sidelink) of the sidelink, and/or may deactivate one or more components of the UE 120, among other examples. Moreover, the UE 120 may operate in a sidelink DRX on mode for a sidelink DRX ON-duration to monitor for sidelink communications from other UEs and/or to transmit sidelink communications to other UEs. The combination of the sidelink DRX sleep duration and the sidelink DRX ON-duration may be referred to as the sidelink DRX cycle duration of the sidelink DRX cycle. On the other hand, a UE 120 in a sidelink DRX sleep state may be active on an access link for uplink transmission and/or downlink reception. The UE 120 may also use the sidelink for other purposes, such as additional measurement and/or testing.

As further shown in FIG. 6, the sidelink DRX operation of the UE 120 may include various types of sidelink DRX cycles, such as a short sidelink DRX cycle and/or a long sidelink DRX cycle. The sidelink DRX cycle duration of the short sidelink DRX cycle may be shorter relative to the sidelink DRX cycle duration of the long sidelink DRX cycle. As an example, a short DRX cycle duration may be five (5) subframes and a long DRX cycle duration may be ten (10) subframes. In some aspects, the UE 120 may transition from short sidelink DRX cycles to long sidelink DRX cycles based on not transmitting and/or not receiving sidelink communications in a particular quantity of consecutive sidelink DRX on mode durations.

In some aspects, the sidelink DRX cycle duration, the sidelink DRX ON-duration, and/or the sidelink DRX sleep duration of the sidelink DRX operation of the UE 120 may be the same or different between the sidelink connected mode and the sidelink idle mode. For example, the sidelink DRX sleep mode duration may be longer in the sidelink idle mode relative to the sidelink connected mode, in which case fewer sidelink DRX ON-durations may be scheduled for a given time period in the sidelink idle mode relative to the sidelink connected mode.

As indicated above, FIG. 6 is provided as an example. Other examples may differ from what is described with regard to FIG. 6.

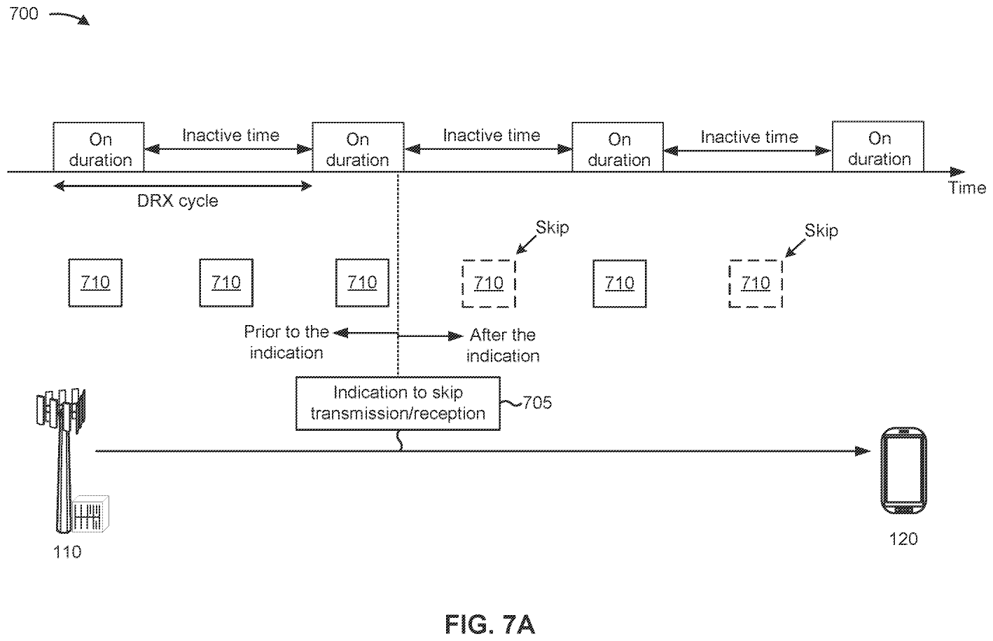

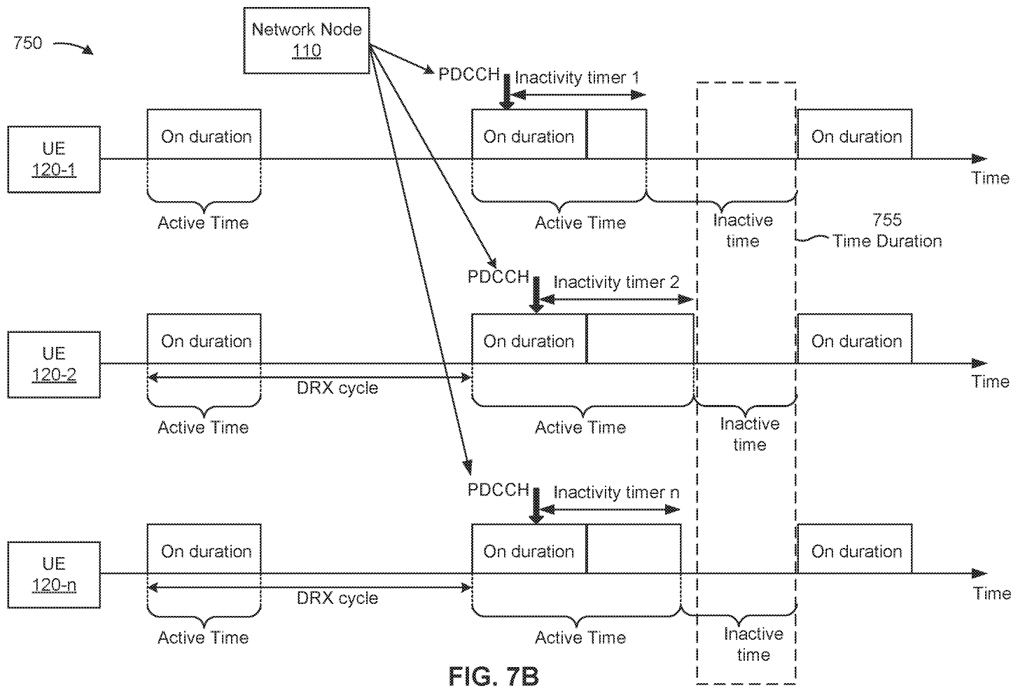

FIG. 7A is a diagram illustrating an example 700 of network DRX and discontinuous transmission (DTX), in accordance with the present disclosure. As shown in FIG. 7A, example 700 includes a UE 120 in communication with a network node 110. In some examples, the UE 120 may be in a connected state (e.g., an RRC connected state) with the network node 110.

Network DRX/DTX (which may also be referred to as cell DRX/DTX) may be achieved by restricting the UE 120 from transmitting and/or receiving particular (e.g., configured) uplink channels and/or downlink channels during an inactive time of a DRX cycle. For example, in uplink, RACH communications, scheduling requests, and/or configured grant communications may be restricted. As another example, in downlink, system information communications, SPS communications, and/or CSI-RS for RRM or RLM may be restricted. Accordingly, an explicit definition and configuration (e.g., on/off duration, inactivity timer, or the like) for network DRX/DTX may not be needed, provided that the UE 120 is aware of when a restriction of transmission and/or reception is enabled. For example, network DRX/DTX may use a DRX framework, as described in connection with FIG. 5, and one or more defined transmission and/or reception restriction rules for one or more uplink and/or downlink channels (e.g., pre-configured uplink and/or downlink channels) during a DRX inactive time.

As shown by reference number 705, the network node 110 may transmit, and the UE 120 may receive, an indication (skipping indication) that the UE 120 is to skip (e.g., drop) transmission and/or reception in DRX inactive times. For example, the UE 120 may receive an indication enabling a transmission and reception (i.e., an uplink and downlink) restriction (or relaxation). The indication may be in DCI, in a MAC-CE, or in RRC signaling. In some examples, the indication may be associated with (e.g., tied to) a DRX switching indication.

As shown in FIG. 7A, prior to the indication, the UE 120 may transmit and/or receive communications 710, that are subject to the indication, during a DRX active time (e.g., during a DRX on duration), as well as during a DRX inactive time, of a DRX cycle. For example, the UE 120 may monitor and/or receive SPS communications (if configured). As another example, the UE 120 may transmit configured grant communications (if configured).

After the indication, the UE 120 may transmit and/or receive restricted communications 710, that are subject to the indication, during a DRX active time (e.g., during a DRX on duration), but not during a DRX inactive time, of a DRX cycle. That is, the UE 120 may skip transmission and/or reception of restricted communications 710 during the DRX inactive time. For example, during a DRX inactive time of a DRX cycle, the UE 120 may not monitor and may not receive SPS communications. As another example, during a DRX inactive time of a DRX cycle, the UE 120 may not transmit configured grant communications.

Accordingly, to achieve power savings, the network node 110 may not transmit and/or receive any downlink and/or uplink signals or channels during a DRX inactive time of a DRX cycle. However, such a relaxation in transmission and/or reception may impact overall performance in a wireless network, such as in connection with time and frequency tracking, beam management (e.g., P2 beam management and/or P3 beam management), RLM, and/or BFD. For example, the UE 120 may perform time and frequency tracking, beam management, RLM, and/or BFD using a CSI-RS during a DRX inactive time of a DRX cycle to identify a suitable receive beam for receiving a PDCCH communication in a subsequent DRX on duration, provided that CSI-RSs are periodically transmitted. Otherwise, the UE 120 would wait for a CSI-RS occasion that falls in a DRX on duration to perform time and frequency tracking, beam management, RLM, and/or BFD, which may affect a timing of receiving the PDCCH communication and overall data communication latency.

Some techniques and apparatus described herein enable the UE 120 to receive and measure reference signals in a DRX inactive time. For example, in some aspects, the UE 120 may receive and measure reference signals in a DRX inactive time even if the UE 120 has received an indication to skip transmission and/or reception in DRX inactive times. In some aspects, the UE 120 may transmit an indication (measurement indication) that the UE 120 performs (e.g., that the UE 120 has the capability to perform) measurement of reference signals in DRX inactive times (which may provide an exception to the skipping indication). The network node 110, responsive to the indication, may transmit reference signals to the UE 120 in a DRX inactive time, and the UE 120 may receive and measure the reference signals in the DRX inactive time. In this way, delays in performing time and frequency tracking, beam management, BFD, and/or RLM may be reduced, thereby improving data communication latency and overall performance of the UE 120's communications.

As indicated above, FIG. 7A is provided as an example. Other examples may differ from what is described with respect to FIG. 7A.

FIG. 7B is a diagram illustrating an example 750 of network DRX and DTX, in accordance with the present disclosure. As shown in FIG. 7B, example 700 includes multiple UEs 120 (shown as UE 120-1, UE 120-2, and UE 120-n) in a cell in communication with a network node 110. In some examples, the UEs 120 may be in a connected state (e.g., an RRC connected state) with the network node 110.

As shown in FIG. 7B, the UEs 120 may perform DRX with respective DRX active times (e.g., that do not fully overlap in time) due to the UEs 120 being configured with different DRX inactivity timer (e.g., drx-InactivityTimer) durations (shown as inactivity timer 1 and inactivity timer 2) and/or due to the UEs 120 starting respective DRX inactivity timers at different times in accordance with a timing of PDCCH reception at the UEs 120. Accordingly, a time duration 755 in which the network node 110 may drop transmission and/or reception (e.g., in accordance with skipping indications to the UEs 120 to skip transmission and/or reception in DRX inactive times) may correspond to a time overlap of DRX inactive times across all UEs 120 (e.g., operating in a connected mode) in the cell, rather than the individual inactive times of each UE 120. This time duration 755 may be referred to as an uplink and/or downlink channel restriction duration. However, a UE 120 may lack information regarding the DRX inactive times of other UEs 120. As a result, the UE 120 may skip transmission and/or reception in a DRX inactive time in accordance with a skipping indication, even though the network node 110 is not in a sleep state, thereby delaying communications at the UE 120 and affecting overall communication latency (e.g., with respect to all channels in DRX inactive times).

Some techniques and apparatuses described herein facilitate indication of the time duration 755, of DRX inactive time, in which an indication to skip transmission and/or reception in DRX inactive times is applicable. Accordingly, the UE 120 may continue to communicate with the network node 110 in a DRX inactive time, regardless of the skipping indication, outside of the time duration 755. In this way, delay in communications of the UE may be reduced, thereby improving data communication latency and overall performance of the UE 120's communications.

As indicated above, FIG. 7B is provided as an example. Other examples may differ from what is described with respect to FIG. 7B.

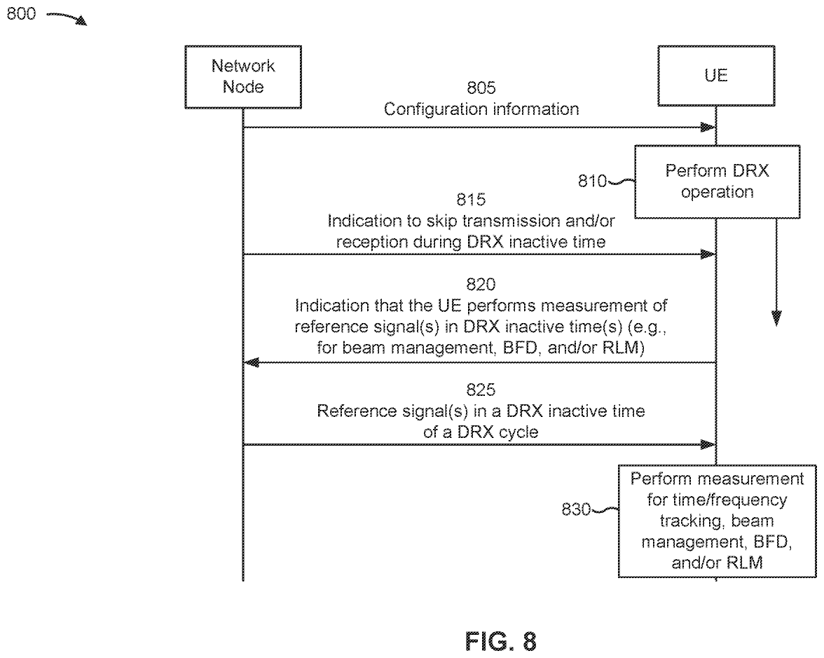

FIG. 8 is a diagram of an example 800 associated with communication skipping in DRX, in accordance with the present disclosure. As shown in FIG. 8, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 8.

As shown by reference number 805, the network node may transmit, and the UE may receive, configuration information. In some aspects, the UE may receive the configuration information via one or more of RRC signaling, one or more MAC-CEs, and/or DCI, among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples.

In some aspects, the configuration information may indicate a DRX configuration (e.g., a C-DRX configuration) for the UE, as described herein. Additionally, or alternatively, the configuration information may indicate one or more sets of reference signal resources (e.g., CSI-RS resources) for the UE, as described herein. For example, the reference signal resources may be for use in connection with time and frequency tracking, beam management, BFD, and/or RLM, among other examples. Additionally, or alternatively, the configuration information may indicate one or more transmission and/or reception restriction (or relaxation) rules for DRX inactive times (e.g., the rules may indicate that SPS communications or CSI-RSs are not to be received by the UE), as described herein. The UE may configure itself based at least in part on the configuration information. In some aspects, the UE may be configured to perform one or more operations described herein based at least in part on the configuration information.

As shown by reference number 810, the UE may perform a DRX operation (e.g., a C-DRX operation) in accordance with the DRX configuration, as described herein. As shown by reference number 815, the network node may transmit, and the UE may receive, an indication to skip (e.g., drop) transmission and/or reception during one or more DRX inactive times of one or more DRX cycles. For example, the indication may enable a restriction (or relaxation) of uplink and/or downlink communication (e.g., the indication may enable one or more of the rules configured for the UE). The indication may be provided in DCI, in a MAC-CE, or in RRC signaling. In some contexts, a time duration in which the indication is applicable may be referred to as a non-active duration, a non-active time duration, or a non-active period of cell DTX and/or cell DRX. In some contexts, the time duration may be referred to as being outside of an active duration for cell DTX and/or cell DRX.

As shown by reference number 820, the UE may transmit, and the network node may receive, an indication that the UE performs measurement of one or more reference signals (e.g., SSBs and/or CSI-RSs, among other examples) during one or more DRX inactive times of one or more DRX cycles. For example, the indication may indicate that the UE performs measurement of reference signals in DRX inactive times. The indication may indicate that the UE performs measurement for at least one of time and frequency tracking, beam management, BFD, and/or RLM. In some aspects, the indication may be in a UE capability information message. As one example, the UE may report whether the UE measures periodic or semi-persistent CSI-RSs in inactive times of C-DRX for time and frequency tracking, beam management, BFD, and/or RLM (e.g., as part of UE capability).

The UE may provide the indication that the UE performs measurement after, or prior to, receiving the indication to skip (e.g., drop) transmission and/or reception. For example, the indication that the UE performs measurement may indicate an exception to the indication to skip transmission and/or reception.

In some aspects, the indication that the UE performs measurement may identify one or more reference signal resources in which the UE is to perform measurement of the one or more reference signals. For example, the indication may identify one or more reference signal resources, from a set of reference signal resources (e.g., a configured set of reference signal resources), in which the UE is to perform measurement. For example, the UE may report the CSI-RS resources, from configured CSI-RS resources, that the UE will measure for time and frequency tracking, beam management, BFD, and/or RLM. That is, the UE may provide UE assistance to the network node.

As shown by reference number 825, the network node may transmit, and the UE may receive, responsive to the indication that the UE performs measurement, one or more reference signals (e.g., reference signal transmissions) during a DRX inactive time (e.g., one or more DRX inactive times) of a DRX cycle (e.g., of one or more DRX cycles). For example, the UE may receive the reference signal(s) if the UE measures reference signals (e.g., CSI-RSs) in DRX inactive times (e.g., in inactive times of C-DRX for time and frequency tracking, beam management, BFD, and/or RLM). The reference signal(s) may include SSBs, CSI-RSs, and/or positioning reference signals, among other examples. For example, the reference signal(s) may include periodic CSI-RSs (e.g., configured by RRC) and/or semi-persistent CSI-RSs (e.g., configured by a MAC-CE).

In some aspects, the reference signal(s) may correspond to (e.g., may be transmitted or received in) all reference signal occasions (e.g., reference signal transmission occasions or reference signal reception occasions) overlapping in time with the DRX inactive time (e.g., that are configured to occur in the DRX inactive time). For example, the network node may not drop reference signal (e.g., CSI-RS) transmissions during DRX inactive times (e.g., during inactive times of C-DRX). In other words, the UE may assume that reference signals (e.g., CSI-RSs) in the inactive time are transmitted as configured. This may be referred to herein as a first dropping operation.

“Reference signal occasion” may refer to a time resource in which a reference signal is configured or scheduled to be communicated. As used herein, “reference signal transmission occasion” may refer to a reference signal occasion from the perspective of the network node, and “reference signal reception occasion” may refer to a reference signal occasion from the perspective of the UE.

In some aspects, the reference signal(s) may correspond to (e.g., may be transmitted or received in) a subset (e.g., a proper subset) of reference signal occasions (e.g., reference signal transmission occasions or reference signal reception occasions) that is less than all reference signal occasions overlapping in time with the DRX inactive time (e.g., that are configured to occur in the DRX inactive time). For example, the network node may drop a subset of the reference signal (e.g., CSI-RS) transmissions during DRX inactive times (e.g., during inactive times of C-DRX). This may be referred to herein as a second dropping operation. As an example, the network node may drop every odd-indexed reference signal occasion or every even-indexed reference signal occasion (e.g., the reference signal occasions may be down-sampled by 2). In some aspects, the subset of reference signal occasions may be referenced from a first reference signal occasion after an end of a DRX active time of the DRX cycle. For example, a reference occasion used to identify the subset of reference signal occasions may be a first reference signal occasion after an end of a DRX active time of the DRX cycle. As an example, a reference for down-sampling the reference signal occasions may be a first reference signal occasion (e.g., CSI-RS occasion) after a DRX active time ends.

In some aspects, the network node may transmit, and the UE may receive, information that identifies the subset of reference signal occasions. For example, the information may identify the reference signal occasions in the subset and/or may identify a pattern of reference signal occasions that form the subset. As an example, the down-sampled reference signal occasions, or a pattern that identifies the down-sampled reference signal occasions, may be indicated by the network node. In some aspects, the UE may identify the down-sampled reference signal occasions, or the pattern that identifies the down-sampled reference signal occasions, in accordance with a fixed rule.

In some aspects, the reference signal(s) may correspond to (e.g., may be transmitted or received in) reference signal occasions (e.g., reference signal transmission occasions or reference signal reception occasions) that are within a particular time interval before a start of a DRX on duration of a subsequent DRX cycle. For example, the UE may assume that reference signal occasions (e.g., CSI-RS occasions) within X symbols or slots before a start of a DRX on duration are not dropped, where X may be an integer greater than zero. This may be referred to herein as a third dropping operation. In some aspects, a duration of the particular time interval may be according to a subcarrier spacing (SCS) of an active downlink bandwidth part (BWP) for the one or more reference signals. For example, the SCS to determine a symbol or a slot duration may be based at least in part on an SCS of an active downlink BWP where the reference signals (e.g., the CSI-RSs) are measured.

In some aspects, the UE may not provide an indication that the UE performs measurement of reference signals during DRX inactive times. For example, the UE may not provide a report of whether the UE measures periodic or semi-persistent CSI-RSs during DRX inactive times of C-DRX for time and frequency tracking, beam management, BFD, and/or RLM. If the UE does not provide the indication, then one of the first dropping operation, the second dropping operation, or the third dropping operation may be used by default (e.g., one of the first dropping operation, the second dropping operation, or the third dropping operation may be assumed).

As shown by reference number 830, the UE may perform measurement of the reference signal(s) (e.g., CSI-RS(s)). For example, the measurement may be a signal strength measurement (e.g., an L1 RSRP measurement). The UE may perform measurement of the reference signal(s) in connection with time and frequency tracking, beam management, BFD, and/or RLM, among other examples, as described herein. By using the indication that the UE performs measurement of reference signals in DRX inactive times, delay in performing time and frequency tracking, beam management, BFD, and/or RLM may be reduced, thereby improving data communication latency and overall performance of the UE's communications.

In some aspects, the techniques described herein may be performed in connection with sidelink DRX. For example, in sidelink DRX, communications described herein between the UE and the network node may instead be between a first UE and a second UE that have established a connection on a sidelink.

As indicated above, FIG. 8 is provided as an example. Other examples may differ from what is described with respect to FIG. 8.

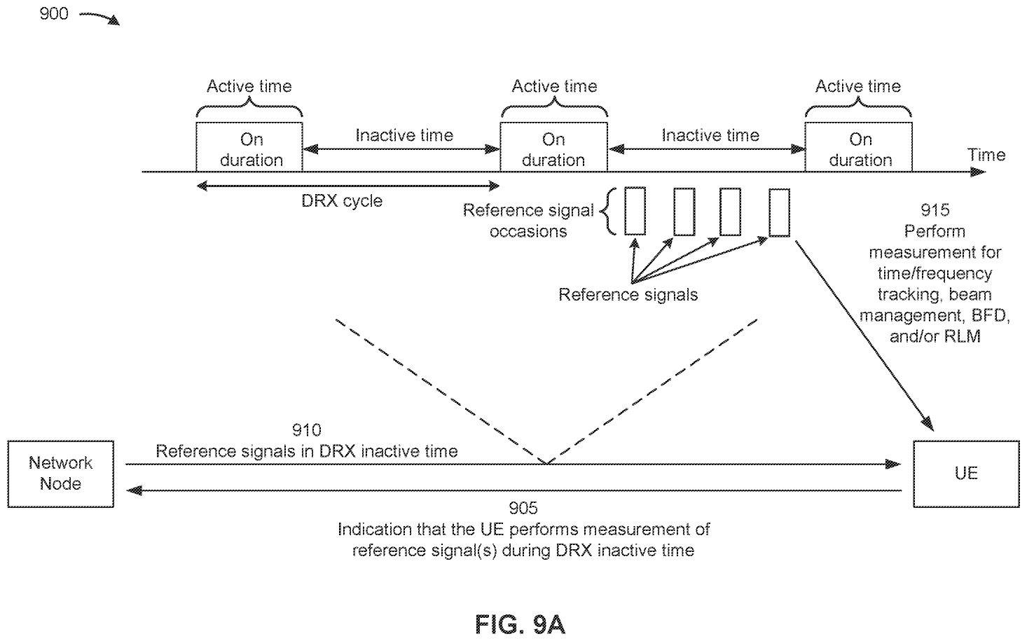

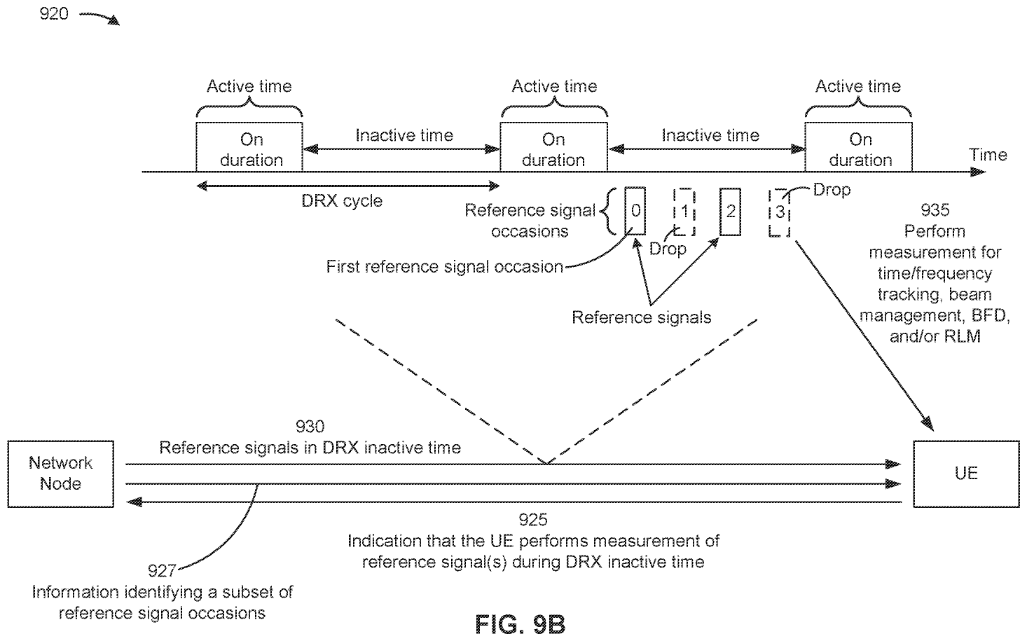

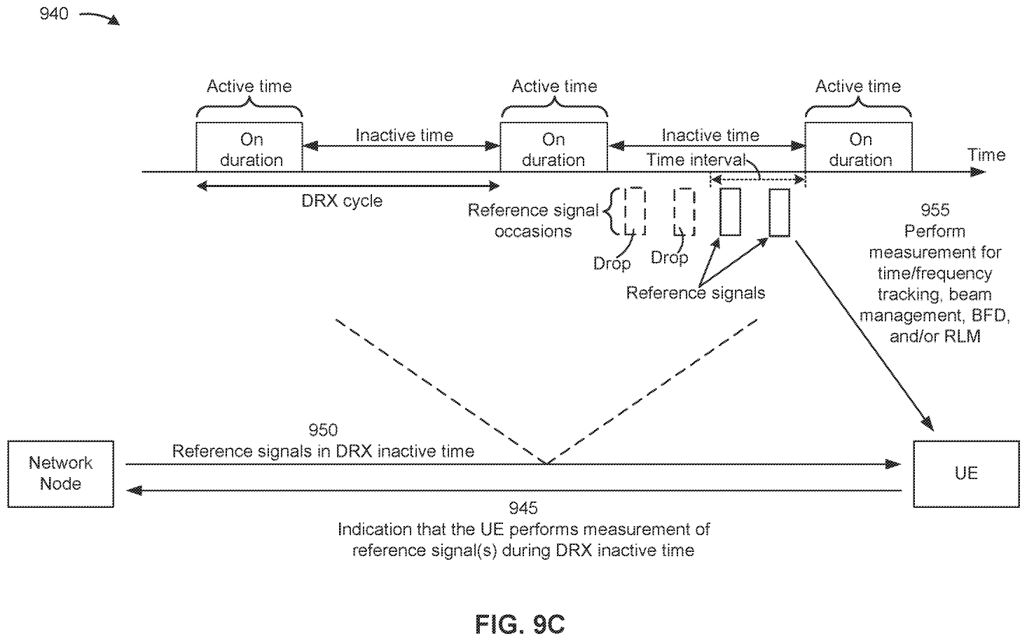

FIG. 9A is a diagram of an example 900 associated with communication skipping in DRX, in accordance with the present disclosure. As shown in FIG. 9A, example 900 includes a UE and a network node, such as the UE and the network node described in connection with FIG. 8.

As shown by reference number 905, the UE may transmit, and the network node may receive, an indication that the UE performs measurement of one or more reference signals (e.g., SSBs and/or CSI-RSs, among other examples) in DRX inactive time, as described in connection with FIG. 8. As shown by reference number 910, the network node may transmit, and the UE may receive, one or more reference signals in a DRX inactive time of a DRX cycle, as described in connection with FIG. 8.

In example 900, the reference signals may correspond to (e.g., may be transmitted or received in) all reference signal occasions (e.g., reference signal transmission occasions or reference signal reception occasions) that are configured in the DRX inactive time (the first dropping operation, described herein). For example, the network node may not drop (shown by reference signal occasions in solid line) any reference signals transmissions configured in the DRX inactive time. As shown by reference number 915, the UE may perform measurement of the received reference signals for use in time and frequency tracking, beam management, BFD, and/or RLM.

As indicated above, FIG. 9A is provided as an example. Other examples may differ from what is described with respect to FIG. 9A.

FIG. 9B is a diagram of an example 920 associated with communication skipping in DRX, in accordance with the present disclosure. As shown in FIG. 9B, example 920 includes a UE and a network node, such as the UE and the network node described in connection with FIG. 8.

As shown by reference number 925, the UE may transmit, and the network node may receive, an indication that the UE performs measurement of one or more reference signals (e.g., SSBs and/or CSI-RSs, among other examples) in DRX inactive time, as described in connection with FIG. 8. As shown by reference number 927, the network node may transmit, and the UE may receive, information identifying a subset of reference signal occasions. As shown by reference number 930, the network node may transmit, and the UE may receive, one or more reference signals in a DRX inactive time of a DRX cycle, as described in connection with FIG. 8.

In example 920, the reference signals may correspond to (e.g., may be transmitted or received in) a subset of all reference signal occasions (e.g., reference signal transmission occasions or reference signal reception occasions) that are configured in the DRX inactive time (the second dropping operation, as described herein). For example, the network node may drop (shown by reference signal occasions in dashed line) a subset of reference signal transmissions configured in the DRX inactive time, and the network node may not drop (shown by reference signal occasions in solid line) another subset of reference signal transmissions configured in the DRX inactive time. Moreover, as shown, a reference occasion, for determining the reference signal occasions in which reference signal transmissions are to be dropped, may be a first reference signal occasion (which may have an index of 0) after an end of a DRX active time of the DRX cycle. For example, as shown, reference signal transmissions may be dropped in odd-indexed reference signal occasions. As shown by reference number 935, the UE may perform measurement of the received reference signals for use in time and frequency tracking, beam management, BFD, and/or RLM.

As indicated above, FIG. 9B is provided as an example. Other examples may differ from what is described with respect to FIG. 9B.

FIG. 9C is a diagram of an example 940 associated with communication skipping in DRX, in accordance with the present disclosure. As shown in FIG. 9C, example 940 includes a UE and a network node, such as the UE and the network node described in connection with FIG. 8.

As shown by reference number 945, the UE may transmit, and the network node may receive, an indication that the UE performs measurement of one or more reference signals (e.g., SSBs and/or CSI-RSs, among other examples) in DRX inactive time, as described in connection with FIG. 8. As shown by reference number 950, the network node may transmit, and the UE may receive, one or more reference signals in a DRX inactive time of a DRX cycle, as described in connection with FIG. 8.

In example 940, the reference signals may correspond to (e.g., may be transmitted or received in) reference signal occasions (e.g., reference signal transmission occasions or reference signal reception occasions) that are within a particular time interval (e.g., a quantity of symbols and/or slots) before a start of a DRX on duration of a subsequent DRX cycle. For example, the network node may drop (shown by reference signal occasions in dashed line) reference signal transmissions in reference signal occasions before the particular time interval, and the network node may not drop (shown by reference signal occasions in solid line) reference signal transmissions in reference signal occasions within the particular time interval. As shown by reference number 955, the UE may perform measurement of the received reference signals for use in time and frequency tracking, beam management, BFD, and/or RLM.

As indicated above, FIG. 9C is provided as an example. Other examples may differ from what is described with respect to FIG. 9C.

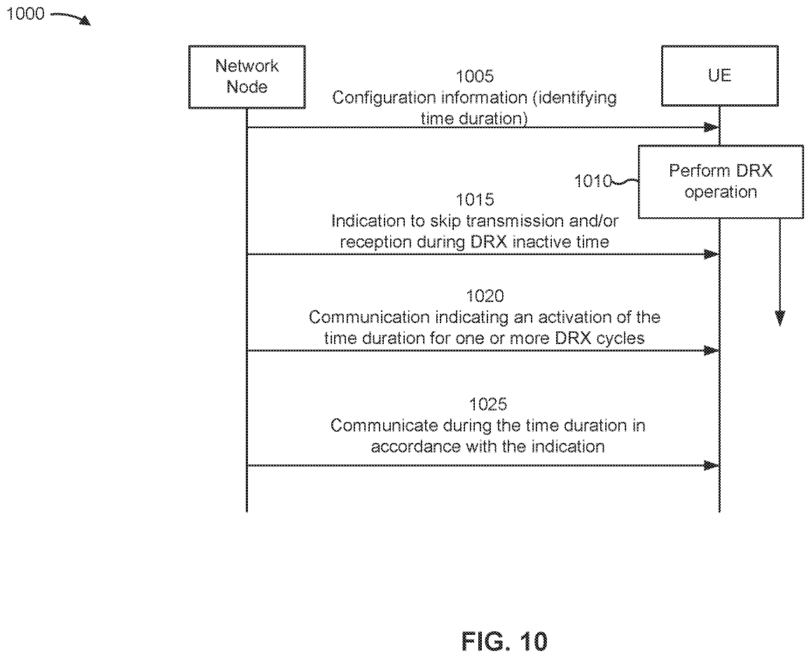

FIG. 10 is a diagram of an example 1000 associated with communication skipping in DRX, in accordance with the present disclosure. As shown in FIG. 10, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 10.

As shown by reference number 1005, the network node may transmit, and the UE may receive, configuration information, in a similar manner as described in connection with FIG. 8. For example, the configuration information may indicate a DRX configuration (e.g., a C-DRX configuration) for the UE, one or more sets of reference signal resources (e.g., CSI-RS resources) for the UE, and/or one or more transmission and/or reception restriction (or relaxation) rules for DRX inactive times.

Additionally, or alternatively, the configuration information may identify a time duration (which may be referred to as an uplink and/or downlink channel restriction duration) of a DRX inactive time of a DRX cycle. The time duration may be for applying an indication to skip transmission and/or reception during the DRX inactive time. For example, during the time duration, the indication to skip transmission and/or reception may be applicable. As an example, the UE may be configured with a time duration in which restriction rule(s) for uplink/downlink channel transmission/reception at the UE is applied. In some aspects, the configuration information may further indicate a periodicity of the time duration. For example, the time duration may be periodic (e.g., the configuration information provides the time duration and the periodicity of the time duration). The time duration may be indicated in milliseconds or as a quantity of slots and/or symbols. In some contexts, the time duration may be referred to as a non-active duration, a non-active time duration, or a non-active period of cell DTX and/or cell DRX. In some contexts, the time duration may be referred to as being outside of an active duration for cell DTX and/or cell DRX.

As shown by reference number 1010, the UE may perform a DRX operation (e.g., a C-DRX operation) in accordance with the DRX configuration, as described herein. As shown by reference number 1015, the network node may transmit, and the UE may receive, the indication to skip (e.g., drop) transmission and/or reception during the DRX inactive time, in a similar manner as described in connection with FIG. 8.

As shown by reference number 1020, the network node may transmit, and the UE may receive, a communication indicating an activation of the time duration for at least the DRX cycle (e.g., for one or more DRX cycles). For example, the time duration may be triggered in an aperiodic manner and/or in a semi-persistent manner by the communication. In some aspects, the communication may be or may include the indication to skip transmission and/or reception. For example, the time duration may be triggered based at least in part on the indication (e.g., an uplink/downlink channel restriction indication).

As shown by reference number 1025, the UE and the network node may communicate during the time duration in accordance with the indication to skip transmission and/or reception. For example, the UE and the network node may communicate during the DRX cycle in accordance with the indication during the time duration. As an example, during the DRX cycle, the UE and the network node may communicate during a DRX active time and/or the UE and the network node may communicate during a DRX inactive time outside of the time duration (or within the time duration provided that the communication is not subject to the indication to skip transmission and/or reception). Moreover, the network node and the UE may skip transmission and/or reception, in accordance with the indication, during the time duration. In a similar manner, the UE and the network node may communicate in multiple DRX cycles in accordance with the time duration (e.g., if the time duration is periodic or semi-persistent).

In some aspects, a portion of the time duration may overlap with a DRX active time of the DRX cycle. In this case, communicating during the DRX cycle in accordance with the indication during the time duration may include transmitting or receiving a communication, without applying the indication (e.g., regardless of the indication), during the portion of the time duration that overlaps with the DRX active time. For example, when the time duration overlaps with the UE's DRX active time, an uplink/downlink channel restriction rule may not be applied (e.g., may be ignored) if an uplink or downlink channel is to be transmitted or received during the overlapped portion of the time duration.

In this way, a DRX/DTX sleep state of the network node may be during the time duration when all UEs in a cell of the network node are in DRX inactive time. Accordingly, the UE may continue to communicate with the network node in a DRX inactive time, regardless of the indication to skip transmission and/or reception, outside of the time duration. In this way, delay in communications of the UE may be reduced, thereby improving data communication latency and overall performance of the UE's communications.

As indicated above, FIG. 10 is provided as an example. Other examples may differ from what is described with respect to FIG. 10.

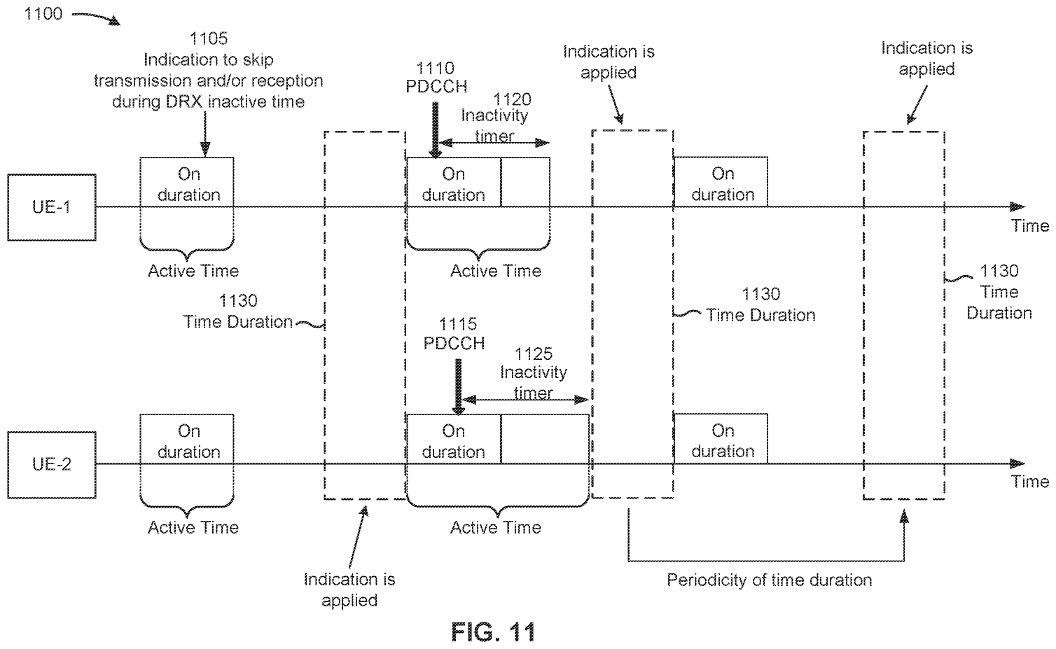

FIG. 11 is a diagram of an example 1100 associated with communication skipping in DRX, in accordance with the present disclosure. Examples 1100 includes a first UE (e.g., a UE 120) shown as UE-1 and a second UE (e.g., a UE 120) shown as UE-2. The first UE and the second UE may be in a connected mode in the same cell. The first UE and the second UE may be performing DRX operations (e.g., according to the same DRX configuration), as described herein.

As shown by reference number 1105, the first UE may receive an indication to skip transmission and/or reception during DRX inactive time (e.g., an uplink/downlink channel restriction indication), as described herein. As shown by reference number 1110, the first UE may receive a first PDCCH communication intended for the first UE at a first time within a DRX on duration of a DRX cycle. As shown by reference number 1115, the second UE may receive a second PDCCH communication intended for the second UE at a second time (e.g., later than the first time) within the DRX on duration of the DRX cycle.

As shown by reference number 1120, the first UE may initiate a first DRX inactivity timer upon reception of the first PDCCH communication. As shown by reference number 1125, the second UE may initiate a second DRX inactivity timer upon reception of the second PDCCH communication. Thus, the first DRX inactivity timer and the second DRX inactivity timer may be initiated at different times. Moreover, as shown, the second DRX inactivity timer may run for a longer time than the first DRX inactivity timer. In other words, the first DRX inactivity timer and the second DRX inactivity timer may terminate at different times. As a result, the first UE and the second UE may have different inactive times in the DRX cycle.

As described herein, the first UE and the second UE may be configured with a time duration 1130 in which an indication to skip transmission and/or reception in DRX inactive time is applicable. For example, as shown, the time duration 1130 may correspond to an overlap of the inactive time of the first UE and the inactive time of the second UE. Thus, in the DRX inactive time, the first UE may apply the indication to skip transmission and/or reception during the time duration 1130 (e.g., but not outside of the time duration 1130). As shown, the time duration 1130 may repeat in DRX cycles according to a periodicity of the time duration 1130. In some aspects, a portion of the time duration 1130 may overlap with a DRX active time of a DRX cycle. In this portion of the time duration 1130, the first UE may transmit or receive a communication without applying the indication.

As indicated above, FIG. 11 is provided as an example. Other examples may differ from what is described with respect to FIG. 11.

FIG. 12 is a diagram illustrating an example process 1200 performed, for example, by a UE, in accordance with the present disclosure. Example process 1200 is an example where the UE (e.g., UE 120) performs operations associated with communication skipping in DRX.

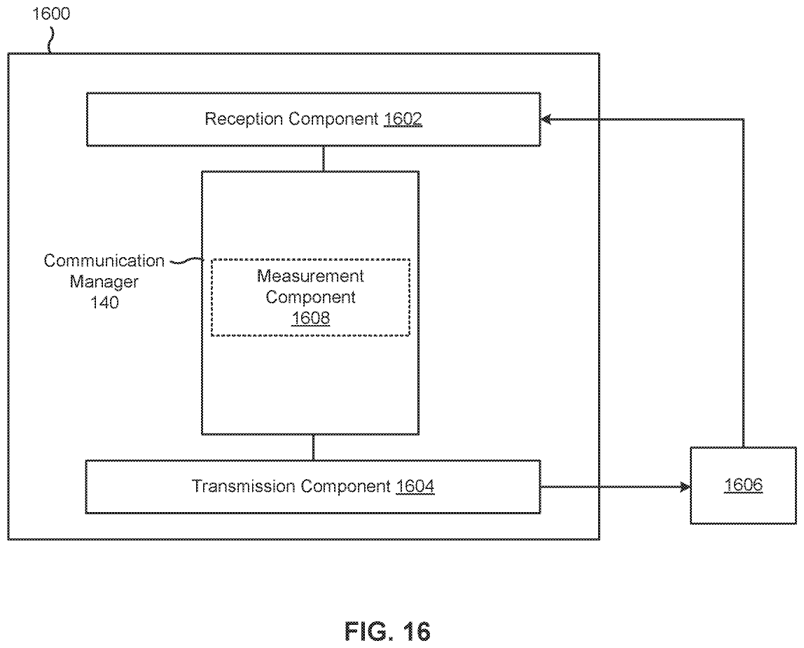

As shown in FIG. 12, in some aspects, process 1200 may include transmitting a first indication that a UE performs measurement of one or more reference signals during one or more DRX inactive times of one or more DRX cycles (block 1210). For example, the UE (e.g., using communication manager 140 and/or transmission component 1604, depicted in FIG. 16) may transmit a first indication that the UE performs measurement of one or more reference signals during one or more DRX inactive times of one or more DRX cycles, as described above.

In some aspects, process 1200 may include (e.g., optionally, as shown by dashed lines) receiving a second indication to skip at least one of transmission or reception during the one or more DRX inactive times of the one or more DRX cycles (block 1212). For example, the UE (e.g., using communication manager 140 and/or reception component 1602, depicted in FIG. 16) may receive a second indication to skip at least one of transmission or reception during the one or more DRX inactive times of the one or more DRX cycles, as described above. In some aspects, process 1200 may include (e.g., optionally, as shown by dashed lines) receiving information that identifies a subset of reference signal occasions (block 1214). For example, the UE (e.g., using communication manager 140 and/or reception component 1602, depicted in FIG. 16) may receive information that identifies a subset of reference signal occasions, as described above.

As further shown in FIG. 12, in some aspects, process 1200 may include receiving, responsive to the first indication, the one or more reference signals during a DRX inactive time, of the one or more DRX inactive times, of a DRX cycle of the one or more DRX cycles (block 1220). For example, the UE (e.g., using communication manager 140 and/or reception component 1602, depicted in FIG. 16) may receive, responsive to the first indication, the one or more reference signals during a DRX inactive time, of the one or more DRX inactive times, of a DRX cycle of the one or more DRX cycles, as described above.

Process 1200 may include additional aspects, such as any single aspect or any combination of aspects described below and/or in connection with one or more other processes described elsewhere herein.

In a first aspect, process 1200 further includes receiving the second indication to skip at least one of transmission or reception during the one or more DRX inactive times of the one or more DRX cycles.

In a second aspect, alone or in combination with the first aspect, the one or more reference signals include at least one of SSBs, CSI-RSs, or positioning reference signals.

In a third aspect, alone or in combination with one or more of the first and second aspects, the one or more reference signals include periodic CSI-RSs.

In a fourth aspect, alone or in combination with one or more of the first through third aspects, the one or more reference signals include semi-persistent CSI-RSs.

In a fifth aspect, alone or in combination with one or more of the first through fourth aspects, the indication indicates that the UE is configured to perform measurement of the one or more reference signals for at least one of time and frequency tracking, beam management, radio link monitoring, or beam failure detection.

In a sixth aspect, alone or in combination with one or more of the first through fifth aspects, the one or more reference signals correspond to all reference signal occasions overlapping in time with the DRX inactive time.

In a seventh aspect, alone or in combination with one or more of the first through sixth aspects, the one or more reference signals correspond to a subset of reference signal occasions overlapping in time with the DRX inactive time.

In an eighth aspect, alone or in combination with one or more of the first through seventh aspects, the subset of reference signal occasions is referenced from a first reference signal occasion after an end of a DRX active time of the DRX cycle.

In a ninth aspect, alone or in combination with one or more of the first through eighth aspects, process 1200 includes receiving information that identifies the subset of reference signal occasions.

In a tenth aspect, alone or in combination with one or more of the first through ninth aspects, the one or more reference signals correspond to reference signal occasions within a particular time interval before a start of a DRX on duration of a subsequent DRX cycle.

In an eleventh aspect, alone or in combination with one or more of the first through tenth aspects, the indication identifies one or more reference signal resources in which the UE is to perform measurement of the one or more reference signals.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network node, in accordance with the present disclosure. Example process 1300 is an example where the network node (e.g., network node 110) performs operations associated with communication skipping in DRX.

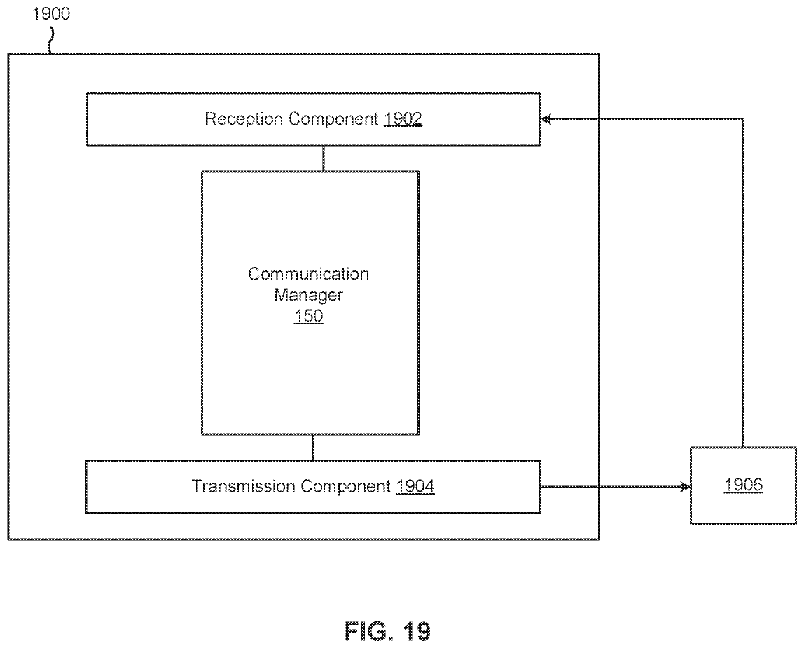

As shown in FIG. 13, in some aspects, process 1300 may include receiving a first indication that a UE performs measurement of one or more reference signals during one or more DRX inactive times of one or more DRX cycles (block 1310). For example, the network node (e.g., using communication manager 150 and/or reception component 1902, depicted in FIG. 19) may receive a first indication that a UE performs measurement of one or more reference signals during one or more DRX inactive times of one or more DRX cycles, as described above.

In some aspects, process 1300 may include (e.g., optionally, as shown by dashed lines) transmitting a second indication to skip at least one of transmission or reception during the one or more DRX inactive times of the one or more DRX cycles (block 1312). For example, the network node (e.g., using communication manager 150 and/or transmission component 1904, depicted in FIG. 19) may transmit a second indication to skip at least one of transmission or reception during the one or more DRX inactive times of the one or more DRX cycles, as described above. In some aspects, process 1300 may include (e.g., optionally, as shown by dashed lines) transmitting information that identifies a subset of reference signal occasions (block 1314). For example, the network node (e.g., using communication manager 150 and/or transmission component 1904, depicted in FIG. 19) may transmit information that identifies a subset of reference signal occasions, as described above.

As further shown in FIG. 13, in some aspects, process 1300 may include transmitting, responsive to the first indication, the one or more reference signals during a DRX inactive time, of the one or more DRX inactive times, of a DRX cycle of the one or more DRX cycles (block 1320). For example, the network node (e.g., using communication manager 150 and/or transmission component 1904, depicted in FIG. 19) may transmit, responsive to the first indication, the one or more reference signals during a DRX inactive time, of the one or more DRX inactive times, of a DRX cycle of the one or more DRX cycles, as described above.

Process 1300 may include additional aspects, such as any single aspect or any combination of aspects described below and/or in connection with one or more other processes described elsewhere herein.

In a first aspect, process 1300 further includes transmitting the second indication to skip at least one of transmission or reception during the one or more DRX inactive times of the one or more DRX cycles.

In a second aspect, alone or in combination with the first aspect, the one or more reference signals include at least one of SSBs, CSI-RSs, or positioning reference signals.

In a third aspect, alone or in combination with one or more of the first and second aspects, the one or more reference signals include periodic CSI-RSs.

In a fourth aspect, alone or in combination with one or more of the first through third aspects, the one or more reference signals include semi-persistent CSI-RSs.

In a fifth aspect, alone or in combination with one or more of the first through fourth aspects, the indication indicates that the UE is configured to perform measurement of the one or more reference signals for at least one of time and frequency tracking, beam management, radio link monitoring, or beam failure detection.

In a sixth aspect, alone or in combination with one or more of the first through fifth aspects, the one or more reference signals correspond to all reference signal occasions overlapping in time with the DRX inactive time.

In a seventh aspect, alone or in combination with one or more of the first through sixth aspects, the one or more reference signals correspond to a subset of reference signal occasions overlapping in time with the DRX inactive time.

In an eighth aspect, alone or in combination with one or more of the first through seventh aspects, the subset of reference signal occasions is referenced from a first reference signal occasion after an end of a DRX active time of the DRX cycle.

In a ninth aspect, alone or in combination with one or more of the first through eighth aspects, process 1300 includes transmitting information that identifies the subset of reference signal occasions.

In a tenth aspect, alone or in combination with one or more of the first through ninth aspects, the one or more reference signals correspond to reference signal occasions within a particular time interval before a start of a DRX on duration of a subsequent DRX cycle.

In an eleventh aspect, alone or in combination with one or more of the first through tenth aspects, the indication identifies one or more reference signal resources in which the UE is to perform measurement of the one or more reference signals.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a UE, in accordance with the present disclosure. Example process 1400 is an example where the UE (e.g., UE 120) performs operations associated with communication skipping in DRX.

As shown in FIG. 14, in some aspects, process 1400 may include receiving information identifying a time duration of a DRX inactive time of a DRX cycle, the time duration being for applying an indication to skip at least one of transmission or reception during the DRX inactive time (block 1410). For example, the UE (e.g., using communication manager 140 and/or reception component 1602, depicted in FIG. 16) may receive information identifying a time duration of a DRX inactive time of a DRX cycle, the time duration being for applying an indication to skip at least one of transmission or reception during the DRX inactive time, as described above.

In some aspects, process 1400 may include (e.g., optionally, as shown by dashed lines) receiving the indication to skip at least one of transmission or reception during the DRX inactive time (block 1412). For example, the UE (e.g., using communication manager 140 and/or reception component 1602, depicted in FIG. 16) may receive the indication to skip at least one of transmission or reception during the DRX inactive time, as described above. In some aspects, process 1400 may include (e.g., optionally, as shown by dashed lines) receiving a communication indicating an activation of the time duration for at least the DRX cycle (block 1414). For example, the UE (e.g., using communication manager 140 and/or reception component 1602, depicted in FIG. 16) may receive a communication indicating an activation of the time duration for at least the DRX cycle, as described above.

As further shown in FIG. 14, in some aspects, process 1400 may include communicating during the time duration in accordance with the indication (block 1420).

For example, the UE (e.g., using communication manager 140, reception component 1602 and/or transmission component 1604, depicted in FIG. 16) may communicate during the time duration in accordance with the indication, as described above. In some aspects, communicating during the time duration may include (e.g., optionally, as shown by dashed lines) transmitting or receiving a communication, without applying the indication, during a portion of the time duration that overlaps with a DRX active time of the DRX cycle (block 1422). For example, the UE (e.g., using communication manager 140, reception component 1602 and/or transmission component 1604, depicted in FIG. 16) may transmit or receive a communication, without applying the indication, during a portion of the time duration that overlaps with a DRX active time of the DRX cycle, as described above.

Process 1400 may include additional aspects, such as any single aspect or any combination of aspects described below and/or in connection with one or more other processes described elsewhere herein.

In a first aspect, process 1400 includes receiving the indication to skip the at least one of transmission or reception during the DRX inactive time.

In a second aspect, alone or in combination with the first aspect, the information further indicates a periodicity of the time duration.

In a third aspect, alone or in combination with one or more of the first and second aspects, process 1400 includes receiving a communication indicating an activation of the time duration for at least the DRX cycle.

In a fourth aspect, alone or in combination with one or more of the first through third aspects, a portion of the time duration overlaps with a DRX active time of the DRX cycle, and communicating during the time duration in accordance with the indication includes transmitting or receiving a communication, without applying the indication, during the portion of the time duration that overlaps with the DRX active time.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a network node, in accordance with the present disclosure. Example process 1500 is an example where the network node (e.g., network node 110) performs operations associated with communication skipping in DRX.

As shown in FIG. 15, in some aspects, process 1500 may include transmitting information identifying a time duration of a DRX inactive time of a DRX cycle, the time duration being for applying an indication to skip at least one of transmission or reception during the DRX inactive time (block 1510). For example, the network node (e.g., using communication manager 150 and/or transmission component 1904, depicted in FIG. 19) may transmit information identifying a time duration of a DRX inactive time of a DRX cycle, the time duration being for applying an indication to skip at least one of transmission or reception during the DRX inactive time, as described above.

In some aspects, process 1500 may include (e.g., optionally, as shown by dashed lines) transmitting the indication to skip at least one of transmission or reception during the DRX inactive time (block 1512). For example, the network node (e.g., using communication manager 150 and/or transmission component 1904, depicted in FIG. 19) may transmit the indication to skip at least one of transmission or reception during the DRX inactive time, as described above. In some aspects, process 1500 may include (e.g., optionally, as shown by dashed lines) transmitting a communication indicating an activation of the time duration for at least the DRX cycle (block 1514). For example, the network node (e.g., using communication manager 150 and/or transmission component 1904, depicted in FIG. 19) may transmit a communication indicating an activation of the time duration for at least the DRX cycle, as described above.

As further shown in FIG. 15, in some aspects, process 1500 may include communicating during the time duration in accordance with the indication (block 1520).

For example, the network node (e.g., using communication manager 150, reception component 1902 and/or transmission component 1904, depicted in FIG. 19) may communicate during the time duration in accordance with the indication, as described above. In some aspects, communicating during the time duration may include (e.g., optionally, as shown by dashed lines) transmitting or receiving a communication, without applying the indication, during a portion of the time duration that overlaps with a DRX active time of the DRX cycle (block 1522). For example, the network node (e.g., using communication manager 150, reception component 1902 and/or transmission component 1904, depicted in FIG. 19) may transmit or receive a communication, without applying the indication, during a portion of the time duration that overlaps with a DRX active time of the DRX cycle, as described above.

Process 1500 may include additional aspects, such as any single aspect or any combination of aspects described below and/or in connection with one or more other processes described elsewhere herein.

In a first aspect, process 1500 includes transmitting the indication to skip the at least one of transmission or reception during the DRX inactive time.

In a second aspect, alone or in combination with the first aspect, the information further indicates a periodicity of the time duration.

In a third aspect, alone or in combination with one or more of the first and second aspects, process 1500 includes transmitting a communication indicating an activation of the time duration for at least the DRX cycle.

In a fourth aspect, alone or in combination with one or more of the first through third aspects, a portion of the time duration overlaps with a DRX active time of the DRX cycle, and communicating during the time duration in accordance with the indication includes transmitting or receiving a communication, without applying the indication, during the portion of the time duration that overlaps with the DRX active time.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication, in accordance with the present disclosure. The apparatus 1600 may be a UE, or a UE may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 140. The communication manager 140 may include a measurement component 1608, among other examples.

In some aspects, the apparatus 1600 may be configured to perform one or more operations described herein in connection with FIGS. 8-11. Additionally, or alternatively, the apparatus 1600 may be configured to perform one or more processes described herein, such as process 1200 of FIG. 12, process 1400 of FIG. 14, or a combination thereof. In some aspects, the apparatus 1600 and/or one or more components shown in FIG. 16 may include one or more components of the UE described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory.

For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the UE described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the UE described in connection with FIG. 2. In some aspects, the transmission component 1604 may be co-located with the reception component 1602 in a transceiver.

In some aspects, the transmission component 1604 may transmit an indication that a UE performs measurement of one or more reference signals during one or more DRX inactive times of one or more DRX cycles. In some aspects, the reception component 1602 may receive, responsive to the indication, the one or more reference signals during a DRX inactive time, of the one or more DRX inactive times, of a DRX cycle of the one or more DRX cycles. In some aspects, the indication is a first indication, and the reception component 1602 may receive a second indication to skip at least one of transmission or reception during the one or more DRX inactive times of the one or more DRX cycles. In some aspects, the reception component 1602 may receive information that identifies a subset of reference signal occasions. In some aspects, the measurement component 1608 may perform measurement of one or more reference signals

In some aspects, the reception component 1602 may receive information identifying a time duration of a DRX inactive time of a DRX cycle, the time duration being for applying an indication to skip at least one of transmission or reception during the DRX inactive time. In some aspects, the reception component 1602 and/or the transmission component 1604 may communicate during the time duration in accordance with the indication. In some aspects, the reception component 1602 may receive the indication to skip the at least one of transmission or reception during the DRX inactive time. In some aspects, the reception component 1602 may receive a communication indicating an activation of the time duration for at least the DRX cycle.

The number and arrangement of components shown in FIG. 16 are provided as an example. In practice, there may be additional components, fewer components, different components, or differently arranged components than those shown in FIG. 16.

Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

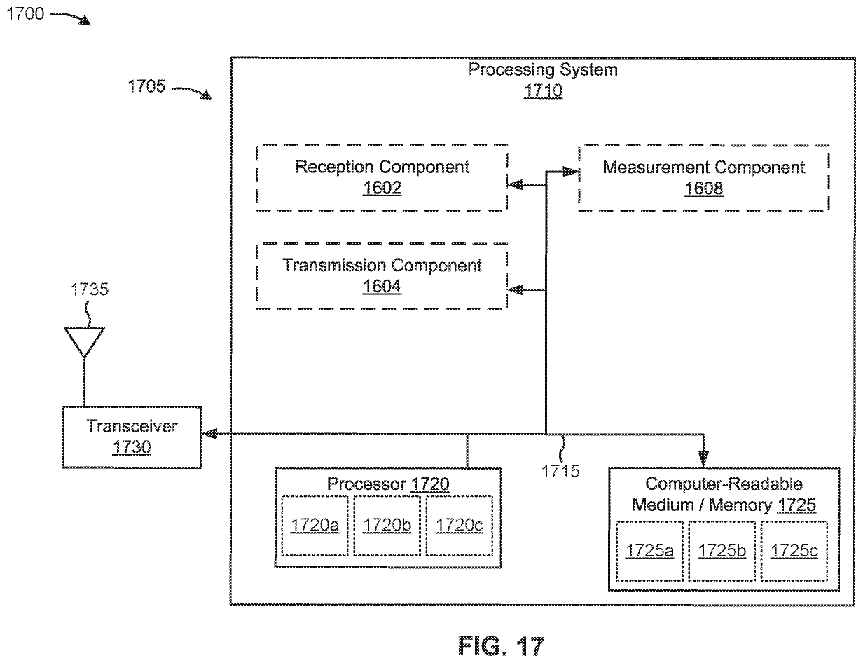

FIG. 17 is a diagram illustrating an example 1700 of a hardware implementation for an apparatus 1705 employing a processing system 1710, in accordance with the present disclosure. The apparatus 1705 may be a UE.

The processing system 1710 may be implemented with a bus architecture, represented generally by the bus 1715. The bus 1715 may include any number of interconnecting buses and bridges depending on the specific application of the processing system 1710 and the overall design constraints. The bus 1715 links together various circuits including one or more processors and/or hardware components, represented by the processor (or processing circuitry) 1720, the illustrated components, and the computer-readable medium/memory (or memory circuitry) 1725. The processor 1720 may include multiple processors, such as processor 1720a, processor 1720b, and processor 1720c. The memory 1725 may include multiple memories, such as memory 1725a, memory 1725b, and memory 1725c. The bus 1715 may also link various other circuits, such as timing sources, peripherals, voltage regulators, and/or power management circuits.

The processing system 1710 may be coupled to a transceiver 1730. The transceiver 1730 is coupled to one or more antennas 1735. The transceiver 1730 provides a means for communicating with various other apparatuses over a transmission medium. The transceiver 1730 receives a signal from the one or more antennas 1735, extracts information from the received signal, and provides the extracted information to the processing system 1710, specifically the reception component 1602. In addition, the transceiver 1730 receives information from the processing system 1710, specifically the transmission component 1604, and generates a signal to be applied to the one or more antennas 1735 based at least in part on the received information.

The processing system 1710 includes a processor 1720 coupled to a computer-readable medium/memory 1725. The processor 1720 is responsible for general processing, including the execution of software stored on the computer-readable medium/memory 1725. The software, when executed by the processor 1720, causes the processing system 1710 to perform the various functions described herein for any particular apparatus. The computer-readable medium/memory 1725 may also be used for storing data that is manipulated by the processor 1720 when executing software.

The processing system further includes at least one of the illustrated components. The components may be software modules running in the processor 1720, resident/stored in the computer readable medium/memory 1725, one or more hardware modules coupled to the processor 1720, or some combination thereof.

In some aspects, the processing system 1710 may be a component of the UE 120 and may include the memory 282 and/or at least one of the TX MIMO processor 266, the receive processor 258, and/or the controller/processor 280. In some aspects, the apparatus 1705 for wireless communication includes means for transmitting an indication that a UE performs measurement of one or more reference signals during one or more DRX inactive times of one or more DRX cycles; means for receiving, responsive to the indication, the one or more reference signals during a DRX inactive time, of the one or more DRX inactive times, of a DRX cycle of the one or more DRX cycles; means for receiving information identifying a time duration of a DRX inactive time of a DRX cycle, the time duration being for applying an indication to skip at least one of transmission or reception during the DRX inactive time; and/or means for communicating during the time duration in accordance with the indication. The aforementioned means may be one or more of the aforementioned components of the apparatus 1600 and/or the processing system 1710 of the apparatus 1705 configured to perform the functions recited by the aforementioned means. As described elsewhere herein, the processing system 1710 may include the TX MIMO processor 266, the receive processor 258, and/or the controller/processor 280. In one configuration, the aforementioned means may be the TX MIMO processor 266, the receive processor 258, and/or the controller/processor 280 configured to perform the functions and/or operations recited herein.

FIG. 17 is provided as an example. Other examples may differ from what is described in connection with FIG. 17.

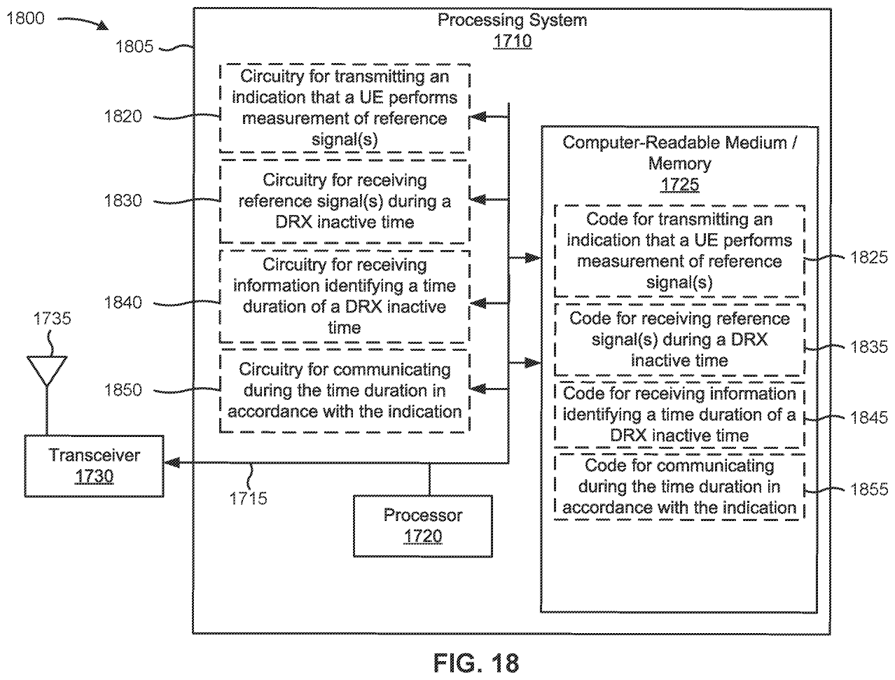

FIG. 18 is a diagram illustrating an example 1800 of an implementation of code and circuitry for an apparatus 1805, in accordance with the present disclosure. The circuitry may include processing circuitry and memory circuitry. The apparatus 1805 may be a UE, or a UE may include the apparatus 1805.

As shown in FIG. 18, the apparatus 1805 may include circuitry for transmitting an indication that a UE performs measurement of one or more reference signals during one or more DRX inactive times of one or more DRX cycles (circuitry 1820). For example, the circuitry 1820 may enable the apparatus 1805 to transmit an indication that a UE performs measurement of one or more reference signals during one or more DRX inactive times of one or more DRX cycles.

As shown in FIG. 18, the apparatus 1805 may include, stored in computer-readable medium 1725, code for transmitting an indication that the UE performs measurement of one or more reference signals during one or more DRX inactive times of one or more DRX cycles (code 1825). For example, the code 1825, when executed by processor 1720, may cause processor 1720 to cause transceiver 1730 to transmit an indication that the UE performs measurement of one or more reference signals during one or more DRX inactive times of one or more DRX cycles.

As shown in FIG. 18, the apparatus 1805 may include circuitry for receiving, responsive to the indication, the one or more reference signals during a DRX inactive time, of the one or more DRX inactive times, of a DRX cycle of the one or more DRX cycles (circuitry 1830). For example, the circuitry 1830 may enable the apparatus 1805 to receive, responsive to the indication, the one or more reference signals during a DRX inactive time, of the one or more DRX inactive times, of a DRX cycle of the one or more DRX cycles.

As shown in FIG. 18, the apparatus 1805 may include, stored in computer-readable medium 1725, code for receiving, responsive to the indication, the one or more reference signals during a DRX inactive time, of the one or more DRX inactive times, of a DRX cycle of the one or more DRX cycles (code 1835). For example, the code 1835, when executed by processor 1720, may cause processor 1720 to cause transceiver 1730 to receive, responsive to the indication, the one or more reference signals during a DRX inactive time, of the one or more DRX inactive times, of a DRX cycle of the one or more DRX cycles.

As shown in FIG. 18, the apparatus 1805 may include circuitry for receiving information identifying a time duration of a DRX inactive time of a DRX cycle, the time duration being for applying an indication to skip at least one of transmission or reception during the DRX inactive time (circuitry 1840). For example, the circuitry 1840 may enable the apparatus 1805 to receive information identifying a time duration of a DRX inactive time of a DRX cycle, the time duration being for applying an indication to skip at least one of transmission or reception during the DRX inactive time.

As shown in FIG. 18, the apparatus 1805 may include, stored in computer-readable medium 1725, code for receiving information identifying a time duration of a DRX inactive time of a DRX cycle, the time duration being for applying an indication to skip at least one of transmission or reception during the DRX inactive time (code 1845). For example, the code 1845, when executed by processor 1720, may cause processor 1720 to cause transceiver 1730 to receive information identifying a time duration of a DRX inactive time of a DRX cycle, the time duration being for applying an indication to skip at least one of transmission or reception during the DRX inactive time.

As shown in FIG. 18, the apparatus 1805 may include circuitry for communicating during the time duration in accordance with the indication (circuitry 1850). For example, the circuitry 1850 may enable the apparatus 1805 to communicate during the time duration in accordance with the indication.

As shown in FIG. 18, the apparatus 1805 may include, stored in computer-readable medium 1725, code for communicating during the time duration in accordance with the indication (code 1855). For example, the code 1855, when executed by processor 1720, may cause processor 1720 to cause transceiver 1730 to communicate during the time duration in accordance with the indication.

FIG. 18 is provided as an example. Other examples may differ from what is described in connection with FIG. 18.

FIG. 19 is a diagram of an example apparatus 1900 for wireless communication, in accordance with the present disclosure. The apparatus 1900 may be a network node, or a network node may include the apparatus 1900. In some aspects, the apparatus 1900 includes a reception component 1902 and a transmission component 1904, which may be in communication with one another (for example, via one or more buses and/or one or more other components). As shown, the apparatus 1900 may communicate with another apparatus 1906 (such as a UE, a base station, or another wireless communication device) using the reception component 1902 and the transmission component 1904. As further shown, the apparatus 1900 may include the communication manager 150. The communication manager 150 may include one or more components for performing operations described herein.

In some aspects, the apparatus 1900 may be configured to perform one or more operations described herein in connection with FIGS. 8-11. Additionally, or alternatively, the apparatus 1900 may be configured to perform one or more processes described herein, such as process 1300 of FIG. 13, process 1500 of FIG. 15, or a combination thereof. In some aspects, the apparatus 1900 and/or one or more components shown in FIG. 19 may include one or more components of the network node described in connection with FIG. 2. Additionally, or alternatively, one or more components shown in FIG. 19 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1902 may receive communications, such as reference signals, control information, data communications, or a combination thereof, from the apparatus 1906. The reception component 1902 may provide received communications to one or more other components of the apparatus 1900. In some aspects, the reception component 1902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1900. In some aspects, the reception component 1902 may include one or more antennas, a modem, a demodulator, a MIMO detector, a receive processor, a controller/processor, a memory, or a combination thereof, of the network node described in connection with FIG. 2.

The transmission component 1904 may transmit communications, such as reference signals, control information, data communications, or a combination thereof, to the apparatus 1906. In some aspects, one or more other components of the apparatus 1900 may generate communications and may provide the generated communications to the transmission component 1904 for transmission to the apparatus 1906. In some aspects, the transmission component 1904 may perform signal processing on the generated communications (such as filtering, amplification, modulation, digital-to-analog conversion, multiplexing, interleaving, mapping, or encoding, among other examples), and may transmit the processed signals to the apparatus 1906. In some aspects, the transmission component 1904 may include one or more antennas, a modem, a modulator, a transmit MIMO processor, a transmit processor, a controller/processor, a memory, or a combination thereof, of the network node described in connection with FIG. 2. In some aspects, the transmission component 1904 may be co-located with the reception component 1902 in a transceiver.

In some aspects, the reception component 1902 may receive an indication that a UE performs measurement of one or more reference signals during one or more DRX inactive times of one or more DRX cycles. In some aspects, the transmission component 1904 may transmit, responsive to the indication, the one or more reference signals during a DRX inactive time, of the one or more DRX inactive times, of a DRX cycle of the one or more DRX cycles. In some aspects, the indication is a first indication, and the transmission component 1904 may transmit a second indication to skip at least one of transmission or reception during the one or more DRX inactive times of the one or more DRX cycles. In some aspects, the transmission component 1904 may transmit information that identifies a subset of reference signal occasions.

In some aspects, the transmission component 1904 may transmit information identifying a time duration of a DRX inactive time of a DRX cycle, the time duration being for applying an indication to skip at least one of transmission or reception during the DRX inactive time. In some aspects, the reception component 1902 and/or the transmission component 1904 may communicate during the time duration in accordance with the indication. In some aspects, the transmission component 1904 may transmit the indication to skip the at least one of transmission or reception during the DRX inactive time. In some aspects, the transmission component 1904 may transmit a communication indicating an activation of the time duration for at least the DRX cycle.

The number and arrangement of components shown in FIG. 19 are provided as an example. In practice, there may be additional components, fewer components, different components, or differently arranged components than those shown in FIG. 19.

Furthermore, two or more components shown in FIG. 19 may be implemented within a single component, or a single component shown in FIG. 19 may be implemented as multiple, distributed components. Additionally, or alternatively, a set of (one or more) components shown in FIG. 19 may perform one or more functions described as being performed by another set of components shown in FIG. 19.

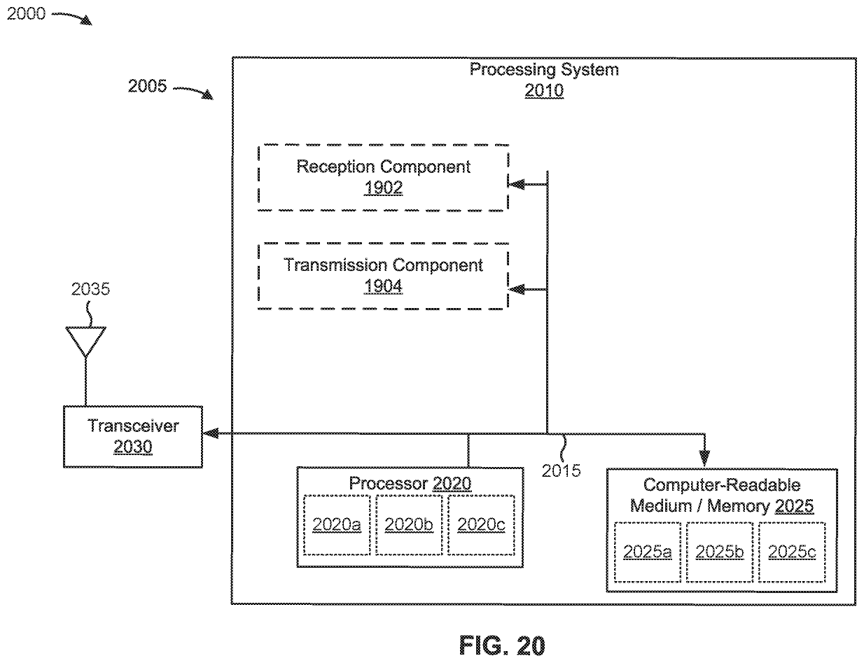

FIG. 20 is a diagram illustrating an example 2000 of a hardware implementation for an apparatus 2005 employing a processing system 2010, in accordance with the present disclosure. The apparatus 2005 may be a network node.

The processing system 2010 may be implemented with a bus architecture, represented generally by the bus 2015. The bus 2015 may include any number of interconnecting buses and bridges depending on the specific application of the processing system 2010 and the overall design constraints. The bus 2015 links together various circuits including one or more processors and/or hardware components, represented by the processor (or processing circuitry) 2020, the illustrated components, and the computer-readable medium/memory (or memory circuitry) 2025. The processor 2020 may include multiple processors, such as processor 2020a, processor 2020b, and processor 2020c. The memory 2025 may include multiple memories, such as memory 2025a, memory 2025b, and memory 2025c. The bus 2015 may also link various other circuits, such as timing sources, peripherals, voltage regulators, and/or power management circuits.

The processing system 2010 may be coupled to a transceiver 2030. The transceiver 2030 is coupled to one or more antennas 2035. The transceiver 2030 provides a means for communicating with various other apparatuses over a transmission medium. The transceiver 2030 receives a signal from the one or more antennas 2035, extracts information from the received signal, and provides the extracted information to the processing system 2010, specifically the reception component 1902. In addition, the transceiver 2030 receives information from the processing system 2010, specifically the transmission component 1904, and generates a signal to be applied to the one or more antennas 2035 based at least in part on the received information.

The processing system 2010 includes a processor 2020 coupled to a computer-readable medium/memory 2025. The processor 2020 is responsible for general processing, including the execution of software stored on the computer-readable medium/memory 2025. The software, when executed by the processor 2020, causes the processing system 2010 to perform the various functions described herein for any particular apparatus. The computer-readable medium/memory 2025 may also be used for storing data that is manipulated by the processor 2020 when executing software.

The processing system further includes at least one of the illustrated components. The components may be software modules running in the processor 2020, resident/stored in the computer readable medium/memory 2025, one or more hardware modules coupled to the processor 2020, or some combination thereof.

In some aspects, the processing system 2010 may be a component of the network node 110 and may include the memory 242 and/or at least one of the TX MIMO processor 230, the receive processor 238, and/or the controller/processor 240. In some aspects, the apparatus 2005 for wireless communication includes means for receiving an indication that a UE performs measurement of one or more reference signals during one or more DRX inactive times of one or more DRX cycles; means for transmitting, responsive to the indication, the one or more reference signals during a DRX inactive time, of the one or more DRX inactive times, of a DRX cycle of the one or more DRX cycles; means for transmitting information identifying a time duration of a DRX inactive time of a DRX cycle, the time duration being for applying an indication to skip at least one of transmission or reception during the DRX inactive time; and/or means for communicating during the time duration in accordance with the indication. The aforementioned means may be one or more of the aforementioned components of the apparatus 1900 and/or the processing system 2010 of the apparatus 2005 configured to perform the functions recited by the aforementioned means. As described elsewhere herein, the processing system 2010 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 20 is provided as an example. Other examples may differ from what is described in connection with FIG. 20.

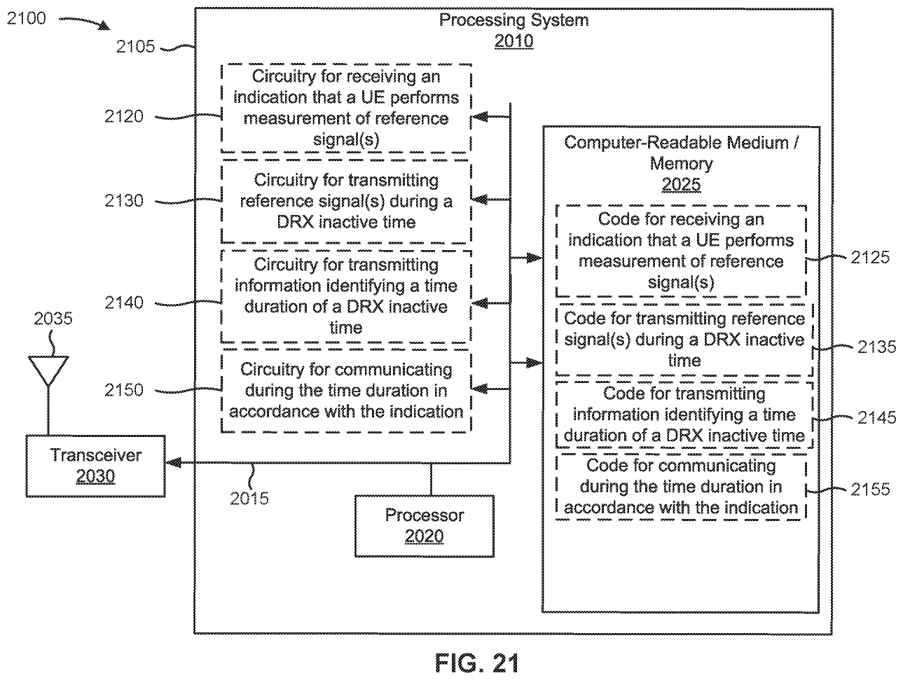

FIG. 21 is a diagram illustrating an example 2100 of an implementation of code and circuitry for an apparatus 2105, in accordance with the present disclosure. The circuitry may include processing circuitry and memory circuitry. The apparatus 2105 may be a network node, or a network node may include the apparatus 2105.

As shown in FIG. 21, the apparatus 2105 may include circuitry for receiving an indication that a UE performs measurement of one or more reference signals during one or more DRX inactive times of one or more DRX cycles (circuitry 2120). For example, the circuitry 2120 may enable the apparatus 2105 to receive an indication that a UE performs measurement of one or more reference signals during one or more DRX inactive times of one or more DRX cycles.

As shown in FIG. 21, the apparatus 2105 may include, stored in computer-readable medium 2025, code for receiving an indication that a UE performs measurement of one or more reference signals during one or more DRX inactive times of one or more DRX cycles (code 2125). For example, the code 2125, when executed by processor 2020, may cause processor 2020 to cause transceiver 2030 to receive an indication that a UE performs measurement of one or more reference signals during one or more DRX inactive times of one or more DRX cycles.

As shown in FIG. 21, the apparatus 2105 may include circuitry for transmitting, responsive to the indication, the one or more reference signals during a DRX inactive time, of the one or more DRX inactive times, of a DRX cycle of the one or more DRX cycles (circuitry 2130). For example, the circuitry 2130 may enable the apparatus 2105 to transmit, responsive to the indication, the one or more reference signals during a DRX inactive time, of the one or more DRX inactive times, of a DRX cycle of the one or more DRX cycles.

As shown in FIG. 21, the apparatus 2105 may include, stored in computer-readable medium 2025, code for transmitting, responsive to the indication, the one or more reference signals during a DRX inactive time, of the one or more DRX inactive times, of a DRX cycle of the one or more DRX cycles (code 2135). For example, the code 2135, when executed by processor 2020, may cause processor 2020 to cause transceiver 2030 to transmit, responsive to the indication, the one or more reference signals during a DRX inactive time, of the one or more DRX inactive times, of a DRX cycle of the one or more DRX cycles.

As shown in FIG. 21, the apparatus 2105 may include circuitry for transmitting information identifying a time duration of a DRX inactive time of a DRX cycle, the time duration being for applying an indication to skip at least one of transmission or reception during the DRX inactive time (circuitry 2140). For example, the circuitry 2140 may enable the apparatus 2105 to transmit information identifying a time duration of a DRX inactive time of a DRX cycle, the time duration being for applying an indication to skip at least one of transmission or reception during the DRX inactive time.

As shown in FIG. 21, the apparatus 2105 may include, stored in computer-readable medium 2025, code for transmitting information identifying a time duration of a DRX inactive time of a DRX cycle, the time duration being for applying an indication to skip at least one of transmission or reception during the DRX inactive time (code 2145). For example, the code 2145, when executed by processor 2020, may cause processor 2020 to cause transceiver 2030 to transmit information identifying a time duration of a DRX inactive time of a DRX cycle, the time duration being for applying an indication to skip at least one of transmission or reception during the DRX inactive time.

As shown in FIG. 21, the apparatus 2105 may include circuitry for communicating during the time duration in accordance with the indication (circuitry 2150). For example, the circuitry 2150 may enable the apparatus 2105 to communicate during the time duration in accordance with the indication.

As shown in FIG. 21, the apparatus 2105 may include, stored in computer-readable medium 2025, code for communicating during the time duration in accordance with the indication (code 2155). For example, the code 2155, when executed by processor 2020, may cause processor 2020 to cause transceiver 2030 to communicate during the time duration in accordance with the indication.

FIG. 21 is provided as an example. Other examples may differ from what is described in connection with FIG. 21.

The following provides an overview of some Aspects of the present disclosure:

Aspect 1: A method of wireless communication performed at an apparatus of a user equipment (UE), comprising: transmitting an indication that the UE performs measurement of one or more reference signals during one or more discontinuous reception (DRX) inactive times of one or more DRX cycles; and receiving, responsive to the indication, the one or more reference signals during a DRX inactive time, of the one or more DRX inactive times, of a DRX cycle of the one or more DRX cycles.

Aspect 2: The method of Aspect 1, wherein the indication is a first indication, and wherein the method further comprises: receiving a second indication to skip at least one of transmission or reception during the one or more DRX inactive times of the one or more DRX cycles.

Aspect 3: The method of any of Aspects 1-2, wherein the one or more reference signals include at least one of synchronization signal blocks (SSBs), channel state information reference signals (CSI-RSs), or positioning reference signals.

Aspect 4: The method of Aspect 3, wherein the one or more reference signals include periodic CSI-RSs.

Aspect 5: The method of any of Aspects 3-4, wherein the one or more reference signals include semi-persistent CSI-RSs.

Aspect 6: The method of any of Aspects 1-5, wherein the indication indicates that the UE performs measurement of the one or more reference signals for at least one of time and frequency tracking, beam management, radio link monitoring, or beam failure detection.

Aspect 7: The method of any of Aspects 1-6, wherein the one or more reference signals correspond to all reference signal occasions overlapping in time with the DRX inactive time.

Aspect 8: The method of any of Aspects 1-6, wherein the one or more reference signals correspond to a subset of reference signal occasions overlapping in time with the DRX inactive time.

Aspect 9: The method of Aspect 8, wherein the subset of reference signal occasions is referenced from a first reference signal occasion after an end of a DRX active time of the DRX cycle.

Aspect 10: The method of any of Aspects 8-9, further comprising: receiving information that identifies the subset of reference signal occasions.

Aspect 11: The method of any of Aspects 1-10, wherein the one or more reference signals correspond to reference signal occasions within a particular time interval before a start of a DRX on duration of a subsequent DRX cycle.

Aspect 12: The method of any of Aspects 1-11, wherein the indication identifies one or more reference signal resources in which the UE is to perform measurement of the one or more reference signals.

Aspect 13: A method of wireless communication performed at an apparatus of a network node, comprising: receiving an indication that a user equipment (UE) performs measurement of one or more reference signals during one or more discontinuous reception (DRX) inactive times of one or more DRX cycles; and transmitting, responsive to the indication, the one or more reference signals during a DRX inactive time, of the one or more DRX inactive times, of a DRX cycle of the one or more DRX cycles.

Aspect 14: The method of Aspect 13, wherein the indication is a first indication, and wherein the method further comprises: transmitting a second indication to skip at least one of transmission or reception during the one or more DRX inactive times of the one or more DRX cycles.

Aspect 15: The method of any of Aspects 13-14, wherein the one or more reference signals include at least one of synchronization signal blocks (SSBs), channel state information reference signals (CSI-RSs), or positioning reference signals.

Aspect 16: The method of Aspect 15, wherein the one or more reference signals include periodic CSI-RSs.

Aspect 17: The method of any of Aspects 15-16, wherein the one or more reference signals include semi-persistent CSI-RSs.

Aspect 18: The method of any of Aspects 13-17, wherein the indication indicates that the UE performs measurement of the one or more reference signals for at least one of time and frequency tracking, beam management, radio link monitoring, or beam failure detection.

Aspect 19: The method of any of Aspects 13-18, wherein the one or more reference signals correspond to all reference signal occasions overlapping in time with the DRX inactive time.

Aspect 20: The method of any of Aspects 13-18, wherein the one or more reference signals correspond to a subset of reference signal occasions overlapping in time with the DRX inactive time.

Aspect 21: The method of Aspect 20, wherein the subset of reference signal occasions is referenced from a first reference signal occasion after an end of a DRX active time of the DRX cycle.

Aspect 22: The method of any of Aspects 20-21, further comprising: transmitting information that identifies the subset of reference signal occasions.

Aspect 23: The method of any of Aspects 13-22, wherein the one or more reference signals correspond to reference signal occasions within a particular time interval before a start of a DRX on duration of a subsequent DRX cycle.

Aspect 24: The method of any of Aspects 13-23, wherein the indication identifies one or more reference signal resources in which the UE is to perform measurement of the one or more reference signals.

Aspect 25: A method of wireless communication performed at an apparatus of a user equipment (UE), comprising: receiving information identifying a time duration of a discontinuous reception (DRX) inactive time of a DRX cycle, the time duration being for applying an indication to skip at least one of transmission or reception during the DRX inactive time; and communicating during the time duration in accordance with the indication.

Aspect 26: The method of Aspect 25, further comprising: receiving the indication to skip the at least one of transmission or reception during the DRX inactive time.

Aspect 27: The method of any of Aspects 25-26, wherein the information further indicates a periodicity of the time duration.

Aspect 28: The method of any of Aspects 25-27, further comprising: receiving a communication indicating an activation of the time duration for at least the DRX cycle.

Aspect 29: The method of any of Aspects 25-28, wherein a portion of the time duration overlaps with a DRX active time of the DRX cycle, and wherein communicating during the time duration in accordance with the indication comprises:

transmitting or receiving a communication, without applying the indication, during the portion of the time duration that overlaps with the DRX active time.

Aspect 30: A method of wireless communication performed at an apparatus of a network node, comprising: transmitting information identifying a time duration of a discontinuous reception (DRX) inactive time of a DRX cycle, the time duration being for applying an indication to skip at least one of transmission or reception during the DRX inactive time; and communicating during the time duration in accordance with the indication.

Aspect 31: The method of Aspect 30, further comprising: transmitting the indication to skip the at least one of transmission or reception during the DRX inactive time.

Aspect 32: The method of any of Aspects 30-31, wherein the information further indicates a periodicity of the time duration.

Aspect 33: The method of any of Aspects 30-32, further comprising: transmitting a communication indicating an activation of the time duration for at least the DRX cycle.

Aspect 34: The method of any of Aspects 30-33, wherein a portion of the time duration overlaps with a DRX active time of the DRX cycle, and wherein communicating during the time duration in accordance with the indication comprises:

transmitting or receiving a communication, without applying the indication, during the portion of the time duration that overlaps with the DRX active time.

Aspect 35: An apparatus for wireless communication at a device, comprising a processor; memory coupled with the processor; and instructions stored in the memory and executable by the processor to cause the apparatus to perform the method of one or more of Aspects 1-12.

Aspect 36: A device for wireless communication, comprising a memory and one or more processors coupled to the memory, the one or more processors configured to perform the method of one or more of Aspects 1-12.

Aspect 37: An apparatus for wireless communication, comprising at least one means for performing the method of one or more of Aspects 1-12.

Aspect 38: A non-transitory computer-readable medium storing code for wireless communication, the code comprising instructions executable by a processor to perform the method of one or more of Aspects 1-12.

Aspect 39: A non-transitory computer-readable medium storing a set of instructions for wireless communication, the set of instructions comprising one or more instructions that, when executed by one or more processors of a device, cause the device to perform the method of one or more of Aspects 1-12.

Aspect 40: An apparatus for wireless communication at a device, comprising a processor; memory coupled with the processor; and instructions stored in the memory and executable by the processor to cause the apparatus to perform the method of one or more of Aspects 13-24.

Aspect 41: A device for wireless communication, comprising a memory and one or more processors coupled to the memory, the one or more processors configured to perform the method of one or more of Aspects 13-24.

Aspect 42: An apparatus for wireless communication, comprising at least one means for performing the method of one or more of Aspects 13-24.

Aspect 43: A non-transitory computer-readable medium storing code for wireless communication, the code comprising instructions executable by a processor to perform the method of one or more of Aspects 13-24.

Aspect 44: A non-transitory computer-readable medium storing a set of instructions for wireless communication, the set of instructions comprising one or more instructions that, when executed by one or more processors of a device, cause the device to perform the method of one or more of Aspects 13-24.

Aspect 45: An apparatus for wireless communication at a device, comprising a processor; memory coupled with the processor; and instructions stored in the memory and executable by the processor to cause the apparatus to perform the method of one or more of Aspects 25-29.

Aspect 46: A device for wireless communication, comprising a memory and one or more processors coupled to the memory, the one or more processors configured to perform the method of one or more of Aspects 25-29.

Aspect 47: An apparatus for wireless communication, comprising at least one means for performing the method of one or more of Aspects 25-29.

Aspect 48: A non-transitory computer-readable medium storing code for wireless communication, the code comprising instructions executable by a processor to perform the method of one or more of Aspects 25-29.

Aspect 49: A non-transitory computer-readable medium storing a set of instructions for wireless communication, the set of instructions comprising one or more instructions that, when executed by one or more processors of a device, cause the device to perform the method of one or more of Aspects 25-29.

Aspect 50: An apparatus for wireless communication at a device, comprising a processor; memory coupled with the processor; and instructions stored in the memory and executable by the processor to cause the apparatus to perform the method of one or more of Aspects 30-34.

Aspect 51: A device for wireless communication, comprising a memory and one or more processors coupled to the memory, the one or more processors configured to perform the method of one or more of Aspects 30-34.

Aspect 52: An apparatus for wireless communication, comprising at least one means for performing the method of one or more of Aspects 30-34.

Aspect 53: A non-transitory computer-readable medium storing code for wireless communication, the code comprising instructions executable by a processor to perform the method of one or more of Aspects 30-34.

Aspect 54: A non-transitory computer-readable medium storing a set of instructions for wireless communication, the set of instructions comprising one or more instructions that, when executed by one or more processors of a device, cause the device to perform the method of one or more of Aspects 30-34.

Aspect 55: An apparatus for wireless communication at a user equipment (UE), comprising: a processing system that includes processor circuitry and memory circuitry that stores code and is coupled with the processor circuitry, the processing system configured to cause the UE to perform the method of one or more of Aspects 1-12.

Aspect 56: An apparatus for wireless communication at a network node, comprising: a processing system that includes processor circuitry and memory circuitry that stores code and is coupled with the processor circuitry, the processing system configured to cause the network node to perform the method of one or more of Aspects 13-24.

Aspect 57: An apparatus for wireless communication at a user equipment (UE), comprising: a processing system that includes processor circuitry and memory circuitry that stores code and is coupled with the processor circuitry, the processing system configured to cause the UE to perform the method of one or more of Aspects 25-29.

Aspect 58: An apparatus for wireless communication at a network node, comprising: a processing system that includes processor circuitry and memory circuitry that stores code and is coupled with the processor circuitry, the processing system configured to cause the network node to perform the method of one or more of Aspects 30-34.

The foregoing disclosure provides illustration and description but is not intended to be exhaustive or to limit the aspects to the precise forms disclosed.

Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

When “a processor” or “one or more processors” is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor individually performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

What is claimed is:

1. An apparatus for wireless communication at a user equipment (UE), comprising:
one or more memories; and
one or more processors coupled to the one or more memories, the one or more processors configured to cause the UE to:
transmit an indication that the UE performs measurement of one or more reference signals during one or more discontinuous reception (DRX) inactive times of one or more DRX cycles; and
receive, responsive to the indication, the one or more reference signals during a DRX inactive time, of the one or more DRX inactive times, of a DRX cycle of the one or more DRX cycles.

2. The apparatus of claim 1, wherein the indication is a first indication, and wherein the one or more processors are further configured to cause the UE to:
receive a second indication to skip at least one of transmission or reception during the one or more DRX inactive times of the one or more DRX cycles.

3. The apparatus of claim 1, wherein the one or more reference signals include at least one of synchronization signal blocks (SSBs), channel state information reference signals (CSI-RSs), or positioning reference signals.

4. The apparatus of claim 3, wherein the one or more reference signals include periodic CSI-RSs or semi-persistent CSI-RSs.

5. The apparatus of claim 1, wherein the indication indicates that the UE is configured to perform measurement of the one or more reference signals for at least one of time and frequency tracking, beam management, radio link monitoring, or beam failure detection.

6. The apparatus of claim 1, wherein the one or more reference signals correspond to all reference signal occasions overlapping in time with the DRX inactive time.

7. The apparatus of claim 1, wherein the one or more reference signals correspond to a subset of reference signal occasions overlapping in time with the DRX inactive time.

8. The apparatus of claim 7, wherein the subset of reference signal occasions is referenced from a first reference signal occasion after an end of a DRX active time of the DRX cycle.

9. The apparatus of claim 7, wherein the one or more processors are further configured to cause the UE to:
receive information that identifies the subset of reference signal occasions.

10. The apparatus of claim 1, wherein the one or more reference signals correspond to reference signal occasions within a particular time interval before a start of a DRX on duration of a subsequent DRX cycle.

11. The apparatus of claim 1, wherein the indication identifies one or more reference signal resources in which the UE is to perform measurement of the one or more reference signals.

12. An apparatus for wireless communication at a network node, comprising:
one or more memories; and
one or more processors coupled to the one or more memories, the one or more processors configured to cause the network node to:
receive an indication that a user equipment (UE) performs measurement of one or more reference signals during one or more discontinuous reception (DRX) inactive times of one or more DRX cycles; and
transmit, responsive to the indication, the one or more reference signals during a DRX inactive time, of the one or more DRX inactive times, of a DRX cycle of the one or more DRX cycles.

13. The apparatus of claim 12, wherein the indication is a first indication, and wherein the one or more processors are further configured to cause the network node to:
transmit a second indication to skip at least one of transmission or reception during the one or more DRX inactive times of the one or more DRX cycles.

14. The apparatus of claim 12, wherein the one or more reference signals include at least one of synchronization signal blocks (SSBs), channel state information reference signals (CSI-RSs), or positioning reference signals.

15. The apparatus of claim 12, wherein the indication indicates that the UE is configured to perform measurement of the one or more reference signals for at least one of time and frequency tracking, beam management, radio link monitoring, or beam failure detection.

16. The apparatus of claim 12, wherein the one or more reference signals correspond to all reference signal occasions overlapping in time with the DRX inactive time.

17. The apparatus of claim 12, wherein the one or more reference signals correspond to a subset of reference signal occasions overlapping in time with the DRX inactive time, and the subset of reference signal occasions is referenced from a first reference signal occasion after an end of a DRX active time of the DRX cycle.

18. The apparatus of claim 12, wherein the one or more reference signals correspond to a subset of reference signal occasions overlapping in time with the DRX inactive time, and
wherein the one or more processors are further configured to cause the network node to:
transmit information that identifies the subset of reference signal occasions.

19. The apparatus of claim 12, wherein the one or more reference signals correspond to reference signal occasions within a particular time interval before a start of a DRX on duration of a subsequent DRX cycle.

20. The apparatus of claim 12, wherein the indication identifies one or more reference signal resources in which the UE is to perform measurement of the one or more reference signals.

21. An apparatus for wireless communication at a user equipment (UE), comprising:
one or more memories; and
one or more processors coupled to the one or more memories, the one or more processors configured to cause the UE to:
receive information identifying a time duration of a discontinuous reception (DRX) inactive time of a DRX cycle, the time duration being for applying an indication to skip at least one of transmission or reception during the DRX inactive time; and
communicate during the time duration in accordance with the indication.

22. The apparatus of claim 21, wherein the one or more processors are further configured to cause the UE to:
receive the indication to skip the at least one of transmission or reception during the DRX inactive time.

23. The apparatus of claim 21, wherein the information further indicates a periodicity of the time duration.

24. The apparatus of claim 21, wherein the one or more processors are further configured to cause the UE to:
receive a communication indicating an activation of the time duration for at least the DRX cycle.

25. The apparatus of claim 21, wherein a portion of the time duration overlaps with a DRX active time of the DRX cycle, and
wherein the one or more processors, to communicate during the time duration in accordance with the indication, are configured to cause the UE to:
transmit or receive a communication, without applying the indication, during the portion of the time duration that overlaps with the DRX active time.

26. An apparatus for wireless communication at a network node, comprising:
one or more memories; and
one or more processors coupled to the one or more memories, the one or more processors configured to cause the network node to:
transmit information identifying a time duration of a discontinuous reception (DRX) inactive time of a DRX cycle, the time duration being for applying an indication to skip at least one of transmission or reception during the DRX inactive time; and
communicate during the time duration in accordance with the indication.

27. The apparatus of claim 26, wherein the one or more processors are further configured to cause the network node to:
transmit the indication to skip the at least one of transmission or reception during the DRX inactive time.

28. The apparatus of claim 26, wherein the information further indicates a periodicity of the time duration.

29. The apparatus of claim 26, wherein the one or more processors are further configured to cause the network node to:
transmit a communication indicating an activation of the time duration for at least the DRX cycle.

30. The apparatus of claim 26, wherein a portion of the time duration overlaps with a DRX active time of the DRX cycle, and
wherein the one or more processors, to communicate during the time duration in accordance with the indication, are configured to cause the network node to:
transmit or receive a communication, without applying the indication, during the portion of the time duration that overlaps with the DRX active time.
